(19) United States
(12) Patent Application Publication
(10) Pub. No.: US 2020/0058922 A1
(43) Pub. Date: Feb. 20, 2020

(54) ELECTROCHEMICAL CELLS AND METHODS OF MAKING AND USING THEREOF

(71) Applicant: VANDERBILT UNIVERSITY, Nashville, TN (US)

(72) Inventors: Adam P. COHN, Nashville, TN (US); Cary L. PINT, Nashville, TN (US)

(21) Appl. No.: 16/347,071

(22) PCT Filed: Nov. 2, 2017
(86) PCT No.: PCT/US2017/059781

§ 371 Date: May 2, 2019

Related U.S. Application Data
(60) Provisional application No. 62/416,446, filed on Nov. 2, 2016.
(60) Provisional application No. 62/573,571, filed on Oct. 17, 2017.

(51) Int. Cl. H01M 4/04; H01M 10/054; H01M 4/58; H01M 4/66; H01M 4/62

(52) U.S. Cl. CPC H01M 4/0447; H01M 4/0485; H01M 4/622; H01M 4/5815; H01M 4/661; H01M 10/054

(57) ABSTRACT

Provided herein are electrochemical cells (e.g., sodium batteries), as well as methods of making and using thereof. The electrochemical cells can employ an “anode-free” design that includes a nucleation layer (e.g., a carbon nucleation layer) disposed on a current collector (e.g., an aluminum current collector). Electrochemical studies show that the modified current collectors can provide highly stable and efficient plating and stripping of sodium metal over a range of currents and sodium loadings with long-term durability. Further, full cells constructed using these modified current collectors can achieve energy densities of greater than 400 Wh/kg, far surpassing recent reports for sodium-ion batteries and even the theoretical maximum for lithium ion battery technology while still relying on naturally abundant raw materials and cost-effective aqueous processing.

### CROSS-REFERENCE TO RELATED APPLICATIONS

This application claims benefit of U.S. Provisional Application No. 62/416,446, filed Nov. 2, 2016, and U.S. Provisional Application No. 62/573,571, filed Oct. 17, 2017, each of which is hereby incorporated herein by reference in its entirety.

### STATEMENT REGARDING FEDERALLY SPONSORED RESEARCH

This invention was made with government support under Grant Nos. 1445197 and 1400424 awarded by the National Science Foundation. The Government has certain rights in the invention.

### BACKGROUND

Due to rapid increases in the use of renewable energy, energy storage systems using batteries has become an area of intense interest. Useable, known rechargeable battery storage systems include lead, nickel/hydrogen, vanadium, and lithium batteries. However, lead batteries and nickel/hydrogen batteries require comparatively larger systems for storing equivalent amounts of energy. Vanadium batteries have been associated with environmental and performance concerns. Lithium batteries exhibit desirably high energy densities and performance characteristics, but are very expensive due to raw material scarcity.

Sodium-ion batteries, on the other hand, are made from highly abundant and thus inexpensive raw materials, and exhibit advantageous charge-discharge, reversibility, coulombic efficiency, and high specific discharge capacity properties. Further, sodium batteries can be fully exhausted (lithium batteries require retention of some charge), and can be more safely stored and transported. Rechargeable sodium batteries can be used for many energy storage applications, including electrical grid storage technologies, portable consumer products, tools, medical products, defense products, transportation, aerospace products and other energy storage devices. As such, recent attention has been focused on developing sodium batteries.

Because charging a sodium-ion battery involves intercalating sodium ions on a negative electrode, the development of electrodes capable of hosting sodium ions has become an area of intense research interest. Sodium ions have a larger ionic radius and less negative standard reduction potential compared to lithium ions, resulting in lower energy densities for sodium-ion batteries. Further, typical graphite anodes cannot intercalate a sufficient amount of sodium ions, and other anode materials have not successfully filled the void. Thus, an anode for a sodium-ion battery which can deliver high capacity and operate at practical currents without sacrificing cycling performance or coulombic efficiency is yet to be realized.

### SUMMARY

Provided herein are electrochemical cells (e.g., sodium batteries), as well as methods of making and using thereof. The electrochemical cells can employ an “anode-free” design that includes a nucleation layer (e.g., a carbon nucleation layer) disposed on a current collector (e.g., an aluminum current collector). Electrochemical studies show that the modified current collectors can provide highly stable and efficient plating and stripping of sodium metal over a range of currents (e.g., up to 4 mA/cm²) and sodium loadings (e.g., up to 12 mAh/cm²) with long-term durability (over 1,000 cycles). Further, full cells constructed using these modified current collectors can achieve energy densities of greater than 400 Wh/kg, far surpassing recent reports for sodium-ion batteries and even the theoretical maximum for lithium ion battery technology (387 Wh/kg for LiCoO₂/graphite cells) while still relying on naturally abundant raw materials and cost-effective aqueous processing.

For example, provided herein are electrochemical cells (e.g., sodium batteries) that comprise a first metal current collector having a nucleation layer disposed on a surface of the first metal current collector; a second metal current collector having a cathode material disposed on a surface of the second metal current collector; and a sodium electrolyte.

The electrochemical cells can exhibit improved energy density and cycle life as compared to existing battery architectures. For example, in some cases, the electrochemical cell (e.g., the sodium battery) can exhibit a ratio of energy discharged to energy stored of at least 97% (e.g., a ratio of energy discharged to energy stored of from 99% to 99.9%).

In some cases, the electrochemical cell (e.g., the sodium battery) can exhibit an energy density of greater than 300 Wh/kg (e.g., greater than 400 Wh/kg) with respect to active mass. For example, in some examples, the electrochemical cell (e.g., the sodium battery) can exhibit an energy density of from 300 Wh/kg to 1000 Wh/kg, or from 400 Wh/kg to 1000 Wh/kg, with respect to active mass.

In some cases, the electrochemical cell (e.g., the sodium battery) can exhibit a mass-specific energy density, measured with respect to the mass of active cathode material and the mass of the nucleation layer, that is at least 40% greater than mass-specific energy density of an analogous electrochemical cell (e.g., a sodium battery) containing a hard carbon anode, measured with respect to the mass of active cathode material and active anode material. In some cases, the electrochemical cell (e.g., the sodium battery) can exhibit a mass-specific energy density, measured with respect to the mass of active cathode material and the mass of the nucleation layer, that is at least 80% of the energy density of the second metal current collector and the cathode material tested in a half cell configuration with a sodium metal counter electrode, measured only with respect to the mass of active cathode material.

The first metal current collector, the second metal current collector, or both the first metal current collector and the second metal current collector comprise an aluminum current collector. In certain embodiments, both the first metal current collector and the second metal current collector comprise an aluminum current collector.

The cathode material can comprise any suitable cathode catalyst for use in an electrochemical cell. In some cases, the cathode material can comprise a sodium containing material, such as a sodium transition metal oxide, a sodium transition metal phosphate, a sodium transition metal fluorophosphate, a sodium transition metal pyrophosphate, a sodium transition metal sulfate, a metal sulfide, a Prussian Blue, or a combination thereof. In one example, the cathode material can comprise sodium vanadium phosphate. In another example, the cathode material can comprise sodiated pyrite.

In some cases, the cathode material can further comprise a sacrificial sodium additive (e.g., sodium metal, Na₂CO₃, Na₃N, Na₃P, or a combination thereof). For example, the cathode material can be prepared by a process that comprises mixing or milling the cathode material with sacrificial sodium additive (e.g., sodium metal) to incorporate sodium into the cathode material. In some cases, the cathode material can comprise a sodiated sodium sink. The sodium sink can comprise a material that has a greater sodium capacity than the second metal current collector, the cathode material, or a combination thereof (e.g., tin) which has been electrochemically sodiated. In some cases, the cathode material can comprise a sodiated conductive additive (e.g., a sodiated carbon additive, such as sodiated carbon nanotubes).

In some cases, the cathode material can further comprise a conductive material (e.g., a conductive carbon material such as carbon black), a binder (e.g., a polymer such as PVDF, PEO, PTFE, SBR (styrene butadiene rubber), acrylic emulsion polymers, cellulosic polymers, copolymers thereof, and blends thereof), or a combination thereof.

The cathode material can be present at an areal loading of from 0.1 to 100 mg/cm² on the surface of the second metal current collector.

The nucleation layer can comprise any material that reduces the nucleation overpotential observed during plating of sodium metal on the nucleation layer relative to the overpotential observed during plating of sodium metal on the bare current collector. For example, the nucleation layer can comprise a carbon nucleation layer, a bismuth nucleation layer, a tin nucleation layer, a metal sulfide nucleation layer, a metal oxide nucleation layer, an antimony nucleation layer, or a phosphorous nucleation layer.

In certain embodiments, the nucleation layer can comprise a carbon nucleation layer. In some cases, the nucleation layer can comprise carbon black, carbon nanotubes, graphene, hard carbon, activated carbon, or a combination thereof. In some cases, the nucleation layer can comprise amorphous carbon (e.g., a carbon black, such as TIMCAL Super C45).

The nucleation layer is present at an areal loading of less than 2 mg/cm² on the surface of the first metal current collector. For example, the nucleation layer can be present at an areal loading of from 20 μg/cm² to 2 mg/cm², from 50 μg/cm² to 2 mg/cm², from 100 μg/cm² to 2 mg/cm², from 200 μg/cm² to 2 mg/cm², from 400 μg/cm² to 2 mg/cm², from 20 μg/cm² to 1 mg/cm², from 50 μg/cm² to 1 mg/cm², from 100 μg/cm² to 1 mg/cm², from 200 μg/cm² to 1 mg/cm², or from 400 μg/cm² to 1 mg/cm² on the surface of the first metal current collector.

The sodium electrolyte can be disposed between the first metal current collector, such that the sodium electrolyte is in contact with the nucleation layer present on a surface of the first metal current collector (or a layer of sodium metal plated on the nucleation layer) and the cathode material. The sodium electrolyte can comprise, for example, a sodium salt (e.g., NaPF₆, NaFSI, or a combination thereof) dissolved in a non-aqueous solvent (e.g., an ether, such as diglyme).

The electrochemical cell can further comprise a separator disposed between the first metal current collector and the second metal current collector. The separator can comprise, for example, a porous polymer membrane or a glass fiber mat.

Also provided herein are methods for preparing electrochemical cells, such as those described above. Methods for preparing electrochemical cells can comprise providing a first metal current collector having a nucleation layer disposed on a surface of the first metal current collector; a second metal current collector having a cathode material disposed on a surface of the second metal current collector; and a sodium electrolyte disposed between the first metal current collector and the second metal current collector (e.g., in contact with the nucleation layer and the cathode material); and (b) plating sodium onto the nucleation layer.

The first metal current collector, nucleation layer, second metal current collector, cathode material, and sodium electrolyte can be any of those described above. In one example, the cathode material can comprise a sodiated sodium transition metal phosphate, such as Na₃₊ₓV₂(PO₄)₃ where 0<x≤2, prior to plating, and a sodium transition metal phosphate, such as NaV₂(PO₄)₃, following plating.

In some cases, the methods for preparing electrochemical cells can further comprise depositing the cathode material on the surface of the second metal current collector, depositing the nucleation layer on the surface of the first metal current collector, or a combination thereof.

Depositing the cathode material of the second metal current collector can comprise combining the cathode material with a binder to form a mixture, and casting the mixture onto the surface of the second metal current collector.

In some cases, the nucleation overpotential observed during plating is less than 19 mV, measured at room temperature using a current of 0.5 mA/cm² in a half cell using a coin cell configuration in 1M NaPF₆ diglyme electrolyte with a 25 micron porous separator. For example, the nucleation overpotential observed during plating can be from 10 mV to 19 mV, measured at room temperature using a current of 0.5 mA/cm² in a half cell using a coin cell configuration in 1M NaPF₆ diglyme electrolyte with a 25 micron porous separator. In some cases, the nucleation layer reduces the nucleation overpotential of sodium metal deposition by at least 20% relative to bare aluminum foil, measured at room temperature using a current of 0.5 mA/cm² in a half cell using a coin cell configuration in 1M NaPF₆ diglyme electrolyte with a 25 micron porous separator. In some cases, the electrochemical cell can exhibit a cathode capacity per cm² that is at least 70% greater than the sodium ion storage capacity of the nucleation layer per cm².

Also provided are methods for increasing the cycle life of an electrochemical cell. Methods for increasing the cycle life of an electrochemical cell can comprise (a) providing a electrochemical cell comprising a first metal current collector; a second metal current collector having a cathode material disposed on a surface of the second metal current collector; and a sodium electrolyte disposed between the first metal current collector and the second metal current collector; and (b) incorporating a sacrificial sodium source in the electrochemical cell prior to assembly.

In some cases, step (b) can comprise combining the cathode material with a sacrificial sodium additive (e.g., sodium metal, Na₂CO₃, Na₃N, Na₃P, and combinations thereof).

In some cases, step (b) can comprise electrochemical sodiation of the cathode material. For example, in one embodiments, the cathode material comprises Na₃V₂(PO₄)₃, and electrochemical sodiation of the cathode material produces Na₄V₂(PO₄)₃.

In some cases, step (b) can comprise combining the cathode material with a sodium sink, and sodiating the sodium sink. The sodium sink can comprise a material (e.g., tin) that has a greater sodium capacity than the second metal current collector, the cathode material, or a combination thereof. Sodiating the sodium sink can comprise, for example, electrochemically sodiating the sodium sink.

In some cases, step (b) can comprise combining the cathode material with a sodiated conductive additive. The sodiated carbon additive can comprise, for example, sodiated carbon nanotubes (e.g., carbon nanotubes whose interior pore space comprises sodium incorporated via vapor phase capillary infiltration/nucleation).

Additional aspects and advantages of the disclosure will be set forth, in part, in the detailed description and any claims which follow, and in part will be derived from the detailed description or can be learned by practice of the various aspects of the disclosure. The advantages described below will be realized and attained by means of the elements and combinations particularly pointed out in the appended claims. It is to be understood that both the foregoing general description and the following detailed description are exemplary and explanatory only and are not restrictive of the disclosure.

### BRIEF DESCRIPTION OF THE FIGURES

The accompanying drawings, which are incorporated in and constitute a part of this specification, illustrate certain examples of the present disclosure and together with the description, serve to explain, without limitation, the principles of the disclosure. Like numbers represent the same element(s) throughout the figures.

FIG. 1(A-D) is a set of graphs showing the role of the carbon nucleation layer on the sodium plating process. (A) Galvanostatic sodiation and then plating for carbon/Al current collector at 40 μA/cm² with carbon loading of 400 μg/cm². (B) Comparison of the sodium nucleation overpotential for bare Al and carbon/Al current collectors at 40 μA/cm². (C) Cycling of bare Al and carbon/Al current collectors at 0.5 mA/cm² with 30 minute plating times with (D) enlarged voltage profiles.

FIG. 2(A-F) is a set of graphs showing voltage hysteresis, coulombic efficiency, stability, and long-term durability of the carbon/Al electrodes. (A) Galvanostatic plating/stripping of sodium on carbon/Al current collectors performed over a range of currents for 30 minute plating times. (B) Nyquist curves performed after initial plating cycles with 0.25 mAh/cm² loading. (C) Galvanostatic plating/stripping of sodium on carbon/Al current collectors performed over a range of times (or loadings) at 1.0 mA/cm². (D) 50 cycles performed at 1 mA/cm² with 12 mAh/cm² loading of sodium with the inset showing a corresponding potential profile (E) Coulombic efficiency and voltage hysteresis from over 1,000 plating/stripping cycles performed at 0.5 mA/cm² with 0.25 mAh/cm² loading. (F) Corresponding potential profiles of the 1^{st}, 2^{nd}, 499^{th}, 500^{th}, 999^{th} and 1000^{th} plating/stripping cycles.

FIG. 3(A-K) is a set of images showing growth and coalescence of sodium islands during the sodium plating process. Photographs (SB=2 mm) and micrographs (SB=500 μm) of sodium metal on carbon/Al electrodes following plating at 0.5 mA/cm² for (A, B) 10 minutes, (C,D) 1 hour, (E, F) 4 hours, and (G, H) 8 hours. (I) SEM image of hexagon-shaped sodium metal island (SB=20 μm). (J) EDS map showing coalescing sodium metal islands (CB=50 μm). (K) Micrograph of plated sodium metal film with 4 mAh/cm² loading (SB=20 μm).

FIG. 4(A-C) shows the design and performance of an anode-free sodium battery. (A) Illustration of the charged and discharged states of the “anode-free” sodium battery utilizing the carbon/Al electrode. (B) Galvanostatic potential profiles of the full cell showing the first 5 cycles at 0.125 mA/cm² from 0.8 to 3.0 V with (C) the delivered energy density of the first 40 cycles with respect to the combined active mass of both electrodes.

FIG. 5 is a schematic showing a pyrite cathode and an in-situ plated sodium metal on a carbon/Al current collector. The expanded view shows the hexagonal arrangement of plated sodium.

FIG. 6(A-B) shows Raman shifting and three-dimensional characteristics of the carbon nucleation layer upon sodiation. (A) Raman spectroscopic characterization of the carbon layer before and after initial sodiation performed using a green (2.33 eV) laser. The D and G peaks labeled correspond to modes originating from defective sp³ carbon bonding and sp² carbon bonding, respectively. The blue-shifting of the G peak may be due to cointercalation of Na ions and diglyme into graphitic domains. (B) SEM micrograph depicting the carbon nucleation layer after sodiation.

FIG. 7(A-B) is a set of graphs comparing initial cycling performance for bare Al electrodes and carbon/Al electrodes. Testing was performed at 0.5 mA/cm² for 30 min plating times. (A) Higher initial Coulombic efficiency is observed for the carbon/Al electrodes compared to bare Al electrodes. (B) More stable performance and reduced hysteresis is observed for the carbon/Al electrodes compared to bare Al electrodes.

FIG. 8 is a graph depicting evaluation of bare Al electrodes at high rates. Device failure occurs when transitioning from 2.0 mA/cm² to 4.0 mA/cm². In contrast, carbon/Al electrodes demonstrated stable performance at 4.0 mA/cm², as shown in FIG. 2A.

FIG. 9 is a graph depicting a comparison of plating hysteresis of a carbon/Al electrode to a bare Cu electrode reported in Seh, Z. W.; Sun, J.; Sun, Y.; Cui, Y. ACS Cent. Sci. 2015, 1, 449-455. Both use 1M NaPF₆ in diglyme electrolyte. The low hysteresis for the carbon/Al electrode is shown to be stable over 1000 cycles whereas the hysteresis for bare Cu electrodes is reported to increase with cycling (from 13.3 mV to 18.4 mV over 300 cycle).

FIG. 10 is a graph depicting cycling of carbon/Al electrodes with different loading times from 30 minutes to 8 hours performed at a current of 1.0 mA/cm².

FIG. 11(A-B) is a set of images depicting an Al electrode plated with sodium metal. (A) 10 mm diameter Al electrode with 2 mAh/cm² of plated sodium metal performed at a rate of 0.5 mA/cm² (4 hour plating duration). (B) Magnified micrograph showing surface detail of plated sodium metal.

FIG. 12(A-B) is a set of SEM images depicting an Al electrode plated with sodium metal. (A) Top-down view of carbon/Al electrode with 0.5 mAh/cm² of plated sodium metal performed at a rate of 0.5 mA/cm² (1 hour plating duration). (B) Magnified micrograph of the surface of the sodium metal. The lightly pitted morphology observed on the surface is attributed to being a result of brief exposure to air during the transfer process.

FIG. 13(A-C) is a set of images depicting an Al electrode plated with sodium metal. (A) Carbon/Al electrode (10 mm diameter) plated with 2 mAh/cm² of plated sodium metal performed at a rate of 4 mA/cm² (30 minute plating duration). (B and C) Surface of the sodium metal at progressive magnifications.

FIG. 14(A-B) is a set of images depicting a cross-sectional view of an Al electrode plated with sodium metal. (A) Cross-sectional SEM image of carbon/Al electrode with 0.5 mAh/cm² of plated sodium metal performed at a rate of 0.5 mA/cm² (1 hour plating duration). (B) Cross-sectional view at greater magnification.

FIG. 15 is an image depicting sodium metal (1 mAh) plated from pre-sodiated FeS₂ on carbon/Al electrode during the first charging of an anode-free full cell. The image shows that sodium metal is formed during charging of the device. To open this cell without shorting the device, testing was performed in a split-flat cell in the glovebox for easy disassembly.

FIG. 16 is a graph depicting cycling characteristics of an anode-free FeS₂ full cell over the first 40 cycles. The top panel shows the Coulombic efficiency of the cell, whereas the bottom panel shows the capacity of the cell over 40 cycles.

FIG. 17 is a chart showing the energy density of sodium-ion anodes formed from various of various materials.

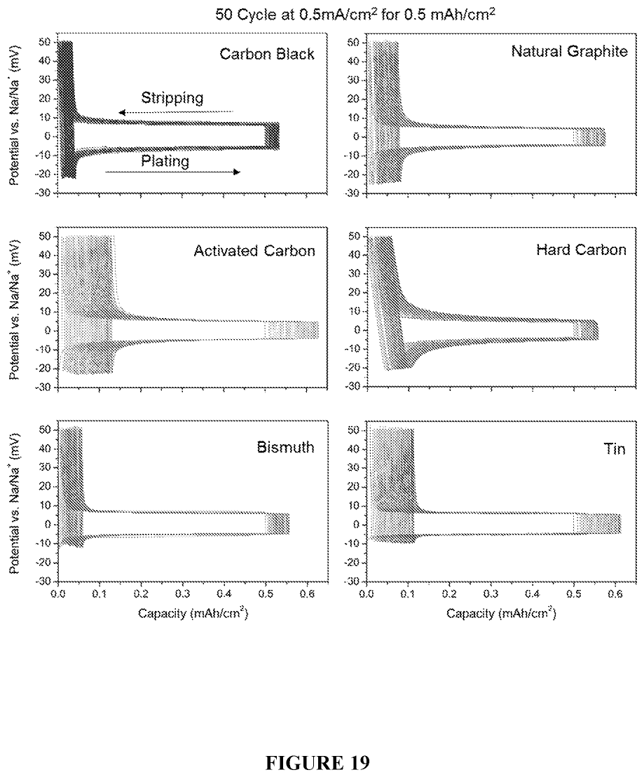

FIG. 18 is a graph showing the galanostatic sodiation/desodiation potential profiles of the different nucleation layers as tested in half cells at 0.1 A/g with respect to the active material in the voltage range of 0 to 2V vs. Na/Na⁺. The lower cutoff at 0 V vs. Na/Na⁺ prevents plating from occurring.

FIG. 19 shows the first 50 cycles of the galvanostatic plating and stripping of 0.5 mAh/cm² of sodium metal at a current density of 0.5 mA/cm² with a 50 mV voltage cutoff (following an initial sodiation of these nucleation layers).

FIG. 20(A-B) is a set of graphs depicting the storage and plating characteristics of four different nucleation layer coatings. (A) shows the first 20 galvanostatic charge discharge profiles for an anode-free cell using a Na₃V₂(PO₄)₃ cathode, performed at 0.25 mA/cm2 (˜C/6). (B) shows a zoomed in plot of the start of the charging process.

FIG. 21 shows the first 80 galvanostatic charge discharge cycles for an anode-free cell using a Na₃V₂(PO₄)₃ cathode, performed at 0.25 mA/cm² (˜C/6). The decrease in capacity with cycling is due to the slow loss of sodium to parasitic reactions.

FIG. 22(A-B) is a set of graphs depicting the performance of an anode-free cell using a Na₄V₂(PO₄)₃ cathode. The full cell includes a Na₄V₂(PO₄)₃ cathode, carbon black nucleation layer, glyme electrolyte, and polymer or glass fiber separator.

FIG. 23 shows galvanostatic cycling of an anode-free cell using a Prussian blue cathode at a rate of ca. 0.1 A/g with respect to the mass of the Prussian Blue between 2.0 and 4.0 V.

### DETAILED DESCRIPTION

The following description of the disclosure is provided as an enabling teaching of the disclosure in its best, currently known embodiment(s). To this end, those skilled in the relevant art will recognize and appreciate that many changes can be made to the various embodiments of described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

### Definitions

Unless defined otherwise, all technical and scientific terms used herein have the same meaning as commonly understood to one of ordinary skill in the art to which this invention belongs. The following definitions are provided for the full understanding of terms used in this specification.

As used herein, the singular forms “a,” “an” and “the” include plural referents unless the context clearly dictates otherwise. Thus, for example, reference to a “metal” includes examples having two or more such “metals” unless the context clearly indicates otherwise.

Ranges can be expressed herein as from “about” one particular value, and/or to “about” another particular value. When such a range is expressed, another example includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Disclosed are the components to be used to prepare the disclosed compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular electrode is disclosed and discussed and a number of modifications that can be made to the electrode are discussed, specifically contemplated is each and every combination and permutation of the electrode and the modifications that are possible unless specifically indicated to the contrary. Thus, if a class of electrodes A, B, and C are disclosed as well as a class of electrodes D, E, and F and an example of a combination electrode, or, for example, a combination electrode comprising A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods.

It is understood that the compositions disclosed herein have certain functions. Disclosed herein are certain structural requirements for performing the disclosed functions, and it is understood that there are a variety of structures which can perform the same function which are related to the disclosed structures, and that these structures will ultimately achieve the same result.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

The terms “disordered carbon” and “amorphous carbon,” as used herein, refer to carbon in which at least 80% (e.g., at least 85%, at least 90%, at least 95%, or essentially 100%) of the carbon is either noncrystalline, or has a microcrystalline random arrangement (i.e., where 80% of the carbon microcrystals are in a random arrangement). In certain embodiments, these carbon materials can have a particle diameter of less than 5 μm (e.g., less than 1 μm), a surface area greater than about 20 m²/g (e.g., greater than 50 m²/g), or a combination thereof.

The term “carbon black,” as used herein, refers to partly crystallized or amorphous spherical particulates (colloids with various origin and contaminations) with average particle sizes of from 10-500 nm, relatively high specific surface area (e.g., from 10-150 m²/g), and relatively low apparent density (e.g., from 0.01-0.2 g/cm³). Carbon black can also be referred to by other terms including channel black, thermal black, lamp black, and acetylene black.

Electrochemical Cells

Provided herein are electrochemical cells (e.g., sodium batteries), as well as methods of making and using thereof. The electrochemical cells can employ an “anode-free” design that includes a nucleation layer (e.g., a carbon nucleation layer) disposed on a current collector (e.g., an aluminum current collector). Electrochemical studies show that the modified current collectors can provide highly stable and efficient plating and stripping of sodium metal over a range of currents (e.g., up to 4 mA/cm²) and sodium loadings (e.g., up to 12 mAh/cm²) with long-term durability (over 1,000 cycles). Further, full cells constructed using these modified current collectors can achieve energy densities of greater than 400 Wh/kg, far surpassing recent reports for sodium-ion batteries and even the theoretical maximum for lithium ion battery technology (387 Wh/kg for LiCoO₂/graphite cells) while still relying on naturally abundant raw materials and cost-effective aqueous processing

For example, provided herein are electrochemical cells (e.g., sodium batteries) that comprise a first metal current collector having a nucleation layer disposed on a surface of the first metal current collector; a second metal current collector having a cathode material disposed on a surface of the second metal current collector; and a sodium electrolyte.

The first metal current collector and the second metal current collector can each be independently fabricated from any suitable conductive material. For example, the first metal current collector, the second metal current collector, or both the first metal current collector and the second metal current collector can be formed from a metal such as nickel, aluminum, titanium, copper, gold, silver, platinum, aluminum alloy, or stainless steel; substances formed by plasma spraying or arc spraying, for example, carbonaceous materials, activated carbon fiber, nickel, aluminum, zinc, copper, tin, lead, or alloys thereof; and conductive films obtained by dispersing a conductive agent in a resin such as rubber or styrene-ethylene-butylene-styrene copolymer (SEBS). In some cases, the first metal current collector, the second metal current collector, or both the first metal current collector and the second metal current collector can be formed from aluminum or aluminum alloy (e.g., an alloy of aluminum and one or more of Mg, Mn, Cr, Zn, Si, Fe, and Ni). In certain embodiments, both the first metal current collector and the second metal current collector comprise an aluminum current collector. The first metal current collector and the second metal current collector can be formed into any suitable shape compatible with the overall design of the electrochemical cell. For example, the first metal current collector and the second metal current collector can each independently be formed as a foil, flat plate, mesh, net, lath, perforated metal or emboss, or a combination of these shapes (for example, meshed flat plate). If desired, irregularities may be formed on the surface of the first metal current collector and/or the second metal current collector, for example, by etching the surface of the current collector.

The cathode material can comprise any suitable cathode catalyst for use in an electrochemical cell (e.g., any material that is capable of reversibly donating and accepting sodium ions). Generally, the cathode material will comprise a sodium inorganic compound (e.g., a bed type active material, a spinel type active material, an olivine type active material, or a combination thereof). In some cases, the cathode material can comprise a sodium containing material, such as a sodium transition metal oxide, a sodium transition metal phosphate, a sodium transition metal fluorophosphate, a sodium transition metal pyrophosphate, a sodium transition metal sulfate, a metal sulfide, a Prussian Blue, or a combination thereof. Specific examples of cathode materials include oxides represented by NaM¹ₐO₂, such as NaFeO₂, NaMnO₂, NaNiO₂, NaVO₂, and NaCoO₂; oxides represented by Na_{0.44}Mn₁₋ₐM¹ₐO₂ where M¹ is at least one transition metal element and 0≤a<1, such as Na(NiₐMn₁₋ₐ)O₂ and Na(FeₐMn₁₋ₐ)O₂; oxides represented by Na_{0.7}Mn₁₋ₐM¹ₐO_{2.05}, wherein M¹ is at least one transition metal element and 0≤a<1; oxides represented by Na_{b}M²_{c}Si₁₂O₃₀, wherein M² is at least one transition metal element, 2≤b≤6, and 2≤c≤5, such as Na₆Fe₂Si₁₂O₃₀ and Na₂Fe₅Si₁₂O₃₀; oxides represented by Na_{d}M³ₑSi₆O₁₈, wherein M³ is at least one transition metal element, 3 and 1 such as Na₂Fe₂Si₆O₁₈ and Na₂MnFeSi₆O₁₈; oxides represented by Na_{f}M⁴_{g}Si₂O₆, wherein M⁴ is at least one element selected from the group consisting of transition metal elements, Mg, and Al, 1 and such as Na₂FeSiO₆; phosphoric acid salts such as NaFePO₄, Na₃Fe₂(PO₄)₃, NaVPO₄F, Na₂FePO₄F, and Na₃V₂(PO₄)₃; boric acid salts such as NaFeBO₄ and Na₃Fe₂(BO₄)₃; and fluorides represented by NaₕM⁵F₆. wherein M⁵ is at least one transition metal element and 2≤h≤3, such as NaFeF₆ and Na₂MnF₆. In one example, the cathode material can comprise sodium vanadium phosphate. In another example, the cathode material can comprise sodiated pyrite.

The cathode material can have any suitable shape. In some cases, the cathode material can have a particulate shape. In some case, the average particle size of the cathode material (D₅₀) can be, for example, 1 nm to 100 μm, such as from 10 nm to 30 μm.

In some cases, an additional sodium-containing material can be incorporated into the cathode material to provide a reservoir of sodium that can be plated on the nucleation layer during cycling. For example, in some cases, the cathode material can further comprise a sacrificial sodium additive (e.g., sodium metal, Na₂CO₃, Na₃N, Na₃P, or a combination thereof). In some cases, the cathode material can comprise a sodiated sodium sink. The sodium sink can comprise a material that has a greater sodium capacity than the second metal current collector, the cathode material, or a combination thereof (e.g., tin) which has been electrochemically sodiated. In some cases, the cathode material can comprise a sodiated conductive additive. The sodiated carbon additive can comprise, for example, sodiated carbon nanotubes. The sodiated carbon nanotubes can comprise carbon nanotubes whose interior pore space comprises sodium incorporated via vapor phase capillary infiltration/nucleation. In some cases, these methods can provide for the incorporation of additional sodium without altering the volume of the material.

When present, the additional sodium-containing material can be incorporated into the cathode material by any suitable process. For example, in some cases, the additional sodium-containing material can be incorporated into the cathode material by a process that comprises mixing or milling the cathode material with additional sodium-containing material to incorporate the additional sodium-containing material into the cathode material.

In some cases, the cathode material can further comprise a conductive material, a binder, or a combination thereof. In order increase battery capacity, it is generally better to maximize the amount of cathode material disposed on the second metal current collector relative to other components, such as conductive material and/or binder. For example, in some embodiments, the conductive material and binder, when present, are present in an amount less than 40% by weight, based on the weight of the cathode material (e.g., less than 35% by weight, less than 30% by weight, less than 25% by weight, less than 20% by weight, less than 15% by weight, less than 10% by weight, or less than 5% by weight).

Examples of conductive materials include carbonaceous materials such as natural graphite, artificial graphite, cokes, and carbon black. Examples of binders include, for example, a fluorinated polymers, polymers derived from ethylenically unsaturated monomers, polysaccharides, copolymers thereof, and blends thereof. Examples of fluorinated polymers include polymers derived from fluorinated alkyl (meth)acrylate monomers (e.g., comprising 1 to 18 carbon atoms); perfluoroalkyl (meth)acrylate monomers (e.g., perfluorododecyl (meth)acrylate, perfluoro n-octyl (meth)acrylate, and perfluoro n-butyl (meth)acrylate); perfluoroalkyl substituted alkyl (meth)acrylate monomers (e.g., perfluorohexylethyl (meth)acrylate and perfluorooctylethyl (meth) acrylate); perfluorooxyalkyl (meth)acrylate monomers (e.g., perfluorododecyloxyethyl (meth)acrylate and perfluorodecyloxyethyl (meth) acrylate); fluorinated alkyl crotonate monomers (e.g., comprising 1 to 18 carbon atoms); fluorinated alkyl malate and fumarate monomers (e.g., comprising 1 to 18 carbon atoms); fluorinated alkyl itaconate monomers (e.g., comprising 1 to 18 carbon atoms); fluorinated alkyl substituted olefin monomers (e.g., comprising from 2 to 10 carbon atoms and from 1 to 17 fluorine atoms, such as perfluorohexyl ethylene); fluorinated olefin monomers in which one or more fluorine atoms are bonded to a double-bonded carbon(s) (e.g., comprising from 2 to 10 carbon atoms and from 1 to 20 fluorine atoms, such as tetrafluoroethylene; trifluoroethylene; vinylidene fluoride; and hexafluoropropylene). Examples of polymers derived from ethylenically unsaturated monomers include polymers derived from (cyclo)alkyl (meth)acrylate monomers (e.g., comprising 1 to 22 carbon atoms, such as methyl (meth)acrylate, ethyl (meth)acrylate, n-butyl (meth) acrylate, iso-butyl (meth) acrylate, cyclohexyl (meth) acrylate, 2-ethylhexyl (meth) acrylate, isodecyl (meth)acrylate, lauryl (meth)acrylate, and octadecyl (meth) acrylate); aromatic ring-containing (meth)acrylate monomers (e.g., benzyl (meth)acrylate and phenylethyl (meth)acrylate); alkylene glycol or dialkylene glycol mono(meth)acrylate monomers (e.g., comprising from 2 to 4 carbon atoms in an alkylene group, such as for example 2-hydroxyethyl (meth)acrylate, 2-hydroxypropyl (meth)acrylate, and diethylene glycol mono(meth)acrylate); (poly)glycerin (e.g., having a degree of polymerization of from 1 to 4) mono(meth)acrylate monomers; (meth)acrylic acid ester monomers, including polyfunctional (meth)acrylate monomers (e.g., (poly)ethylene glycol (e.g., having a degree of polymerization of from 1 to 100) di(meth)acrylate, (poly)propylene glycol (e.g., having a degree of polymerization of from 1 to 100) di(meth)acrylate, 2,2-bis(4-hydroxyethyl phenyl)propane di(meth)acrylate, and trimethylolpropane tri(meth)acrylate); (meth)acrylamide monomers, including (meth)acrylamide and (meth)acrylamide derivatives (e.g., N-methylol (meth)acrylamide and diacetone acrylamide); cyano group-containing monomers (e.g., (meth)acrylonitrile, 2-cyanoethyl (meth)acrylate, and 2-cyanoethyl acrylamide); styrene monomers, such as styrene and styrene derivatives having 7 to 18 carbon atoms (e.g., α-methylstyrene, vinyl toluene, p-hydroxystyrene, and divinylbenzene); diene monomers, such as alkadienes having from 4 to 12 carbon atoms (e.g., butadiene, isoprene, and chloroprene); alkenyl ester monomers, such as carboxylic acid vinyl ester monomers (e.g., comprising 2 to 12 carbon atoms, such as vinyl acetate, vinyl propionate, vinyl butyrate, and vinyl octanoate, which may be partially or completely saponified as in polyvinyl alcohol) and carboxylic acid (meth)allyl ester monomers (e.g., comprising 2 to 12 carbon atoms, such as (meth)allyl acetate, (meth)allyl propionate, and (meth)allyl octanoate); epoxy group-containing monomers, such as glycidyl (meth)acrylate and (meth)allyl glycidyl ether; monoolefin monomers, such as monoolefin monomers having from 2 to 12 carbon atoms (e.g., ethylene, propylene, 1-butene, 1-octene, and 1-dodecene); monomers comprising one or more halogens other than fluorine (e.g., monomers comprising one or more chlorine atoms, one or more bromine atoms, one or more iodine atoms, or a combination thereof), such as vinyl chloride and vinylidene chloride; (meth)acrylic acids such as acrylic acid and methacrylic acid; conjugated double bond-containing monomers, such as butadiene and isoprene; and copolymers and blends thereof, such as ethylene-vinyl acetate copolymers, styrene-butadiene copolymers, and ethylene-propylene copolymers. Examples of polysaccharides include starch, methylcellulose, carboxymethylcellulose, hydroxymethylcellulose, hydroxyethylcellulose, hydroxypropylcellulose, carboxymethylhydroxyethylcellulose, and nitrocellulose, and derivatives thereof. Examples of other suitable binders include, for example, phenol resins, melamine resins, polyurethane resins, urea resins, polyamide resin, polyimide resins, polyamide-imide resins, petroleum pitch, and coal pitch.

In some embodiments, the cathode material can be present at an areal loading of at least 0.1 mg/cm² on the surface of the second metal current collector (e.g., at least 0.5 mg/cm², at least 1 mg/cm², at least 5 mg/cm², at least 10 mg/cm², at least 25 mg/cm², at least 50 mg/cm², or at least 75 mg/cm²) on the surface of the second metal current collector. In some embodiments, the cathode material can be present at an areal loading of 100 mg/cm² or less on the surface of the second metal current collector (e.g., 75 mg/cm² or less, 50 mg/cm² or less, 25 mg/cm² or less, 10 mg/cm² or less, 5 mg/cm² or less, 1 mg/cm² or less, or 0.5 mg/cm² or less).

The cathode material can be present on the surface of the second metal current collector at an areal loading ranging from any of the minimum values described above to any of the maximum values described above. For example, the cathode material can be present on the surface of the second metal current collector at an areal loading of from 0.1 to 100 mg/cm² (e.g., 0.1 to 50 mg/cm², or from 5 to 50 mg/cm²). Also, the thickness of the cathode active material layer varies greatly with the constitution of the battery, and is preferably within a range of 0.1 μm to 1,000 μm, for example.

The nucleation layer can comprise any material that reduces the nucleation overpotential observed during plating of sodium metal on the nucleation layer relative to the overpotential observed during plating of sodium metal on the bare current collector. For example, the nucleation layer can comprise a carbon nucleation layer, a bismuth nucleation layer, a tin nucleation layer, a metal sulfide nucleation layer, a metal oxide nucleation layer, an antimony nucleation layer, or a phosphorous nucleation layer.

In certain embodiments, the nucleation layer can comprise a carbon nucleation layer. Carbon nucleation layers can comprise one or more carbon materials. Carbon materials have a differing surface chemistry depending on the chemical make-up of the carbon material which can comprise sp² hybridized, sp³ hybridized, or a combination of sp² and sp³ hybridized carbon bonding in a solid. sp² hybridized carbons involve electrons confined to the in-plane direction (the ab plane of graphite, for example) whereas sp³ hybridized carbons involve electrons that extend into out-of-plane (c axis of graphite, for example) bonds. The diverse collection of carbon materials known have surfaces that, besides roughness, are only different based upon the inherent ratio of sp²/sp³ carbons in the material. In the case of materials such as graphene and single-walled carbon nanotubes, the materials are comprised primarily of sp² hybridized carbons. In the case of materials such as activated carbons, carbon black, carbon nanofibers, and multi-walled carbon nanotubes, the materials involve a make up involving a mixture of both sp² and sp³ carbons with varying ratios.

The nature of a nucleation event on a carbon surface, such as the nucleation of sodium onto carbon, will be mechanistically steered by the ratio of sp²/sp³ carbons on the surface where nucleation takes place. By definition, nucleation onto a surface is described by classical nucleation theory where a critical radius of a nuclei must be achieved before nucleation and growth of a particle will take place. It is known that different chemical interaction between a nuclei and the surface onto which nucleation takes place can modify the nucleation energetics, or alternatively the size of the critical nuclei. This implies that carbon materials with different blends of sp² and sp³ hybridized bonds will yield differing surface nucleation properties that will dictate their optimal characteristics as a viable nucleation layer in the device described herein.

In some cases, the nucleation layer can comprise carbon black, carbon nanotubes, graphene, hard carbon, activated carbon, or a combination thereof. In some cases, the nucleation layer can comprise amorphous carbon (e.g., a carbon black, such as TIMCAL Super C45).

In some embodiments, the nucleation layer can be present at an areal loading of less than 2 mg/cm² on the surface of the first metal current collector (e.g., less than 1.75 mg/cm², less than 1.5 mg/cm², less than 1.25 mg/cm², less than 1 mg/cm², less than 900 μg/cm², less than 800 μg/cm², less than 700 μg/cm², less than 600 μg/cm², less than 500 μg/cm², less than 400 μg/cm², less than 300 μg/cm², less than 200 μg/cm², less than 100 μg/cm², or less than 50 μg/cm²). In some embodiments, the nucleation layer can be present at an areal loading of at least 20 μg/cm² on the surface of the first metal current collector (e.g., at least 50 μg/cm², at least 100 μg/cm², at least 200 μg/cm², at least 300 μg/cm², at least 400 μg/cm², at least 500 μg/cm², at least 600 μg/cm², at least 700 μg/cm², at least 800 μg/cm², at least 900 μg/cm², at least 1 mg/cm², at least 1.25 mg/cm², at least 1.5 mg/cm², or at least 1.75 mg/cm²).

The nucleation layer can be present on the surface of the first metal current collector at an areal loading ranging from any of the minimum values described above to any of the maximum values described above. For example, the nucleation layer can be present on the surface of the first metal current collector at an areal loading of from 20 μg/cm² to 2 mg/cm², from 50 μg/cm² to 2 mg/cm², from 100 μg/cm² to 2 mg/cm², from 200 μg/cm² to 2 mg/cm², from 400 μg/cm² to 2 mg/cm², from 20 μg/cm² to 1 mg/cm², from 50 μg/cm² to 1 mg/cm², from 100 μg/cm² to 1 mg/cm², from 200 μg/cm² to 1 mg/cm², or from 400 μg/cm² to 1 mg/cm².

Nucleation is a surface process. Accordingly, the nucleation layer can in principle be a single atomic layer in thickness so as to provide for an interface (surface) for sodium nucleation. In some embodiments described herein, the nucleation layer can have a thickness of 100 Angstroms or less (e.g., 75 Angstroms or less, 50 Angstroms or less, 40 Angstroms or less, 30 Angstroms or less, 25 Angstroms or less, 20 Angstroms or less, or 10 Angstroms or less.

The sodium electrolyte can be disposed between the first metal current collector, such that the sodium electrolyte is in contact with the nucleation layer present on a surface of the first metal current collector (or a layer of sodium metal plated on the nucleation layer) and the cathode material. The electrolyte serves as a medium for ion conduction between the nucleation layer present on a surface of the first metal current collector (or a layer of sodium metal plated on the nucleation layer) and the cathode material. The term “sodium electrolyte,” as used herein, is intended to encompass any material that can provide for the conduction of sodium ions. In some cases, the sodium electrolyte can comprise a sodium salt. The form of the electrolyte s not particularly limited. For example, the electrolyte can be a liquid electrolyte, a gel electrolyte, or a solid electrolyte layer.

Liquid electrolytes can comprise a sodium salt dissolved in a nonaqueous solvent. Examples of sodium salts include inorganic sodium salts such as NaPF₆, NaBF₄, NaClO₄, NaFSI, and NaAsF₆; and organic sodium salts such as NaCF₃SO₃, NaN(CF₃SO₂)₂, NaN(C₂F₅SO₂)₂, NaN (FSO₂)₂ and NaC(CF₃SO₂)₃.

The nonaqueous solvent can be any suitable nonaqueous solvent that con dissolve the sodium salt. Examples of suitable solvents include high-dielectric-constant solvents such as cyclic esters (cyclic carbonates such as ethylene carbonate (EC), propylene carbonate (PC) and butylene carbonate (BC)), γ-butyrolactone; sulfolane, N-methylpyrrolidone (NMP), and 1,3-dimethyl-2-imidazolidinone (DMI). Other suitable solvents include low-viscosity solvents such as chain ester (chain carbonate such as dimethyl carbonate (DMC), diethyl carbonate (DEC) and ethyl methyl carbonate (EMC))), acetates such as methyl acetate and ethyl acetate, and ethers such as 2-methyltetrahydrofuran and diglyme. In other cases, an ionic liquid may be used. Mixtures of solvents, such as mixtures of high dielectric constant solvents the low viscosity solvents) can also be used. The concentration of the sodium salt in the nonaqueous solvent can be, for example, from 0.3 mol/L to 5 mol/L (e.g., from 0.8 mol/L to 1.5 mol/L).

In certain embodiments, the sodium electrolyte can comprise, for example, a sodium salt (e.g., NaPF₆, NaFSI, or a combination thereof) dissolved in a non-aqueous solvent (e.g., an ether, such as diglyme).

Gel electrolytes can be obtained by adding a gel-forming polymer to the liquid electrolytes described above. Suitable gel-forming polymers are known in the art, and include, for example, polyethylene oxide (PEO), polyacrylonitrile (PAN), and polymethyl methacrylate (PMMA).

Solid electrolytes include solid materials that exhibit sodium ion conductivity. Such solid materials may be amorphous or crystalline, and formed into any suitable shape. In some cases, the solid materials can be particulate solids, for example, having an average particle size (D₅₀) of from 1 nm to 100 μm (e.g., from 10 nm to 30 μm). This solid electrolyte can before formed into a layer having a thickness of from 0.1 μm to 1,000 μm (e.g., 0.1 μm to 300 μm). Examples of suitable solid materials include oxide based solid electrolyte materials (e.g., Na₃Zr₂Si₂PO₁₂ and (3-alumina solid electrolytes such as Na₂O-11Al₂O₃) and sulfide solid electrolyte material (e.g., Na₂S—P₂S₅).

The electrochemical cells can further comprise a separator disposed between the first metal current collector and the second metal current collector. The separator can comprise, for example, a porous polymer membrane or a glass fiber mat. Examples of suitable separators include porous polymer membranes, such as polyethylene (PE), polypropylene (PP), cellulose and polyvinylidene fluoride; and nonwoven fabrics such as resin nonwoven fabrics and glass fiber nonwoven fabrics. The separator can comprise a single-layer structure (such as a PE or PP membrane) or a laminated structure (such as a PP/PE/PP membrane).

The electrochemical cells can further comprise additional components, such as contacts, a casing (e.g., a casing formed from SUS), and/or wiring. If desired for a particular application, additional components can be included, such as safety devices to prevent hazards if the cell overheats, ruptures, or short circuits. The electrochemical cell can further include, for example, electronics, storage media, processors, software encoded on computer readable media, and other complex regulatory components.

In certain embodiments, the electrochemical cell can be a battery. The batteries can be of any suitable type, such as a coin cell, a jelly rolls, or a prismatic cell. Batteries can contain more than one electrochemical cell, and can optionally contain components to connect and/or regulate these multiple electrochemical cells.

The electrochemical cells described herein can exhibit improved energy density and cycle life as compared to existing battery architectures. For example, in some cases, the electrochemical cell (e.g., the sodium battery) can exhibit a ratio of energy discharged to energy stored of at least 97% (e.g., a ratio of energy discharged to energy stored of from 99% to 99.9%).

In some embodiments, the electrochemical cells (e.g., the sodium batteries) can exhibit an energy density of greater than 300 Wh/kg (e.g., greater than 400 Wh/kg, greater than 500 Wh/kg, greater than 600 Wh/kg, greater than 700 Wh/kg, greater than 800 Wh/kg, or greater than 900 Wh/kg) with respect to active mass. In some embodiments, the electrochemical cells (e.g., the sodium batteries) can exhibit an energy density of 1000 Wh/kg or less (e.g., 900 Wh/kg or less, 800 Wh/kg or less, 700 Wh/kg or less, 600 Wh/kg or less, 500 Wh/kg or less, or 400 Wh/kg or less) with respect to active mass.

The electrochemical cells (e.g., the sodium batteries) can exhibit an energy density ranging from any of the minimum values described above to any of the maximum values described above. For example, in some examples, the electrochemical cells (e.g., the sodium batteries) can exhibit an energy density of from 300 Wh/kg to 1000 Wh/kg, or from 400 Wh/kg to 1000 Wh/kg, with respect to active mass.

In some cases, the electrochemical cells (e.g., the sodium batteries) can exhibit a mass-specific energy density, measured with respect to the mass of active cathode material and the mass of the nucleation layer, that is at least 40% greater (e.g., at least 50% greater, at least 60% greater, at least 70% greater, at least 80% greater, at least 90% greater, or at least 100% greater) than mass-specific energy density of an analogous electrochemical cell (e.g., a sodium battery) containing a hard carbon anode, measured with respect to the mass of active cathode material and active anode material. In some embodiments, the electrochemical cells (e.g., the sodium batteries) can exhibit a mass-specific energy density, measured with respect to the mass of active cathode material and the mass of the nucleation layer, that is from 40% to 100% greater (e.g. from 40% to 80% greater, from 40% to 60% greater, from 60% to 80% greater, or from 60% to 100% greater) than mass-specific energy density of an analogous electrochemical cell (e.g., a sodium battery) containing a hard carbon anode, measured with respect to the mass of active cathode material and active anode material.

In some cases, the electrochemical cells (e.g., the sodium batteries) can exhibit a mass-specific energy density, measured with respect to the mass of active cathode material and the mass of the nucleation layer, that is at least 80% (e.g., at least 85%, at least 90%, or at least 95%) of the energy density of the second metal current collector and the cathode material tested in a half cell configuration with a sodium metal counter electrode, measured only with respect to the mass of active cathode material.

The electrochemical cells (e.g., sodium ion batteries) described herein can be used in a variety of applications. In some cases, the cells can be in the form of standard battery size formats usable by a consumer interchangeably in a variety of devices. The cells can be in power packs, for instance for tools and appliances. The cells can be usable in consumer electronics including cameras, cell phones, gaming devices, or laptop computers. The cells can also be usable in larger devices, such as electric automobiles, motorcycles, buses, delivery trucks, trains, or boats. Furthermore, the electrochemical cells (e.g., sodium ion batteries) described herein can have industrial uses, such as energy storage in connection with energy production, for instance in a smart grid, or in energy storage for factories or health care facilities, for example in the place of generators.

Methods of Making Electrochemical Cells

Also provided herein are methods for preparing electrochemical cells, such as those described above. Methods for preparing electrochemical cells can comprise providing a first metal current collector having a nucleation layer disposed on a surface of the first metal current collector; a second metal current collector having a cathode material disposed on a surface of the second metal current collector; and a sodium electrolyte disposed between the first metal current collector and the second metal current collector (e.g., in contact with the nucleation layer and the cathode material); and (b) plating sodium onto the nucleation layer.

The first metal current collector, nucleation layer, second metal current collector, cathode material, and sodium electrolyte can be any of those described above. In one example, the cathode material can comprise a sodiated sodium transition metal phosphate, such as Na₃₊ₓV₂(PO₄)₃ where 0<x≤2, prior to plating, and a sodium transition metal phosphate, such as NaV₂(PO₄)₃, following plating.

In some cases, the methods for preparing electrochemical cells can further comprise depositing the cathode material on the surface of the second metal current collector, depositing the nucleation layer on the surface of the first metal current collector, or a combination thereof.

Depositing the cathode material of the second metal current collector can comprise combining the cathode material with a binder to form a mixture, and casting the mixture onto the surface of the second metal current collector.

In some cases, the nucleation layer can be formed from a material which provides a desirable nucleation overpotential during plating when utilized in one of the standard coin cells described herein. For example, in some cases, the nucleation overpotential observed during plating can be less than 19 mV (e.g., less than 18 mV, less than 17 mV, less than 16 mV, less than 15 mV, less than 14 mV, less than 13 mV, less than 12 mV, or less than 11 mV), measured at room temperature using a current of 0.5 mA/cm² in a half cell using a coin cell configuration in 1M NaPF₆ diglyme electrolyte with a 25 micron porous separator. In some cases, the nucleation overpotential observed during plating can be at least 10 mV (e.g., at least 11 mV, at least 12 mV, at least 13 mV, at least 14 mV, at least 15 mV, at least 16 mV, at least 17 mV, or at least 18 mV), measured at room temperature using a current of 0.5 mA/cm² in a half cell using a coin cell configuration in 1M NaPF₆ diglyme electrolyte with a 25 micron porous separator.

The nucleation overpotential observed during plating can range from any of the minimum values described above to any of the maximum values described above. For example, the nucleation overpotential observed during plating can be from 10 mV to 19 mV, measured at room temperature using a current of 0.5 mA/cm² in a half cell using a coin cell configuration in 1M NaPF₆ diglyme electrolyte with a 25 micron porous separator.

In some cases, the nucleation layer reduces the nucleation overpotential of sodium metal deposition by at least 20% (e.g., at least 30%, at least 40%, or at least 50%) relative to bare aluminum foil, measured at room temperature using a current of 0.5 mA/cm² in a half cell using a coin cell configuration in 1M NaPF₆ diglyme electrolyte with a 25 micron porous separator. In some cases, the electrochemical cell can exhibit a cathode capacity per cm² that is at least 70% greater (e.g., at least 80%, or at least 90% greater) than the sodium ion storage capacity of the nucleation layer per cm².

Methods of Increasing the Cycle Life of an Electrochemical Cell

Also provided are methods for increasing the cycle life of an electrochemical cell. Methods for increasing the cycle life of an electrochemical cell can comprise (a) providing a electrochemical cell comprising a first metal current collector; a second metal current collector having a cathode material disposed on a surface of the second metal current collector; and a sodium electrolyte disposed between the first metal current collector and the second metal current collector; and (b) incorporating a sacrificial sodium source in the electrochemical cell prior to assembly.

In some cases, step (b) can comprise combining the cathode material with a sacrificial sodium additive (e.g., sodium metal, Na₂CO₃, Na₃N, Na₃P, and combinations thereof).

In some cases, step (b) can comprise electrochemical sodiation of the cathode material. For example, in one embodiments, the cathode material comprises Na₃V₂(PO₄)₃, and electrochemical sodiation of the cathode material produces Na₄V₂(PO₄)₃.

In some cases, step (b) can comprise combining the cathode material with a sodium sink, and sodiating the sodium sink. The sodium sink can comprise a material (e.g., tin) that has a greater sodium capacity than the second metal current collector, the cathode material, or a combination thereof. Sodiating the sodium sink can comprise, for example, electrochemically sodiating the sodium sink.

In some cases, step (b) can comprise combining the cathode material with a sodiated conductive additive. The sodiated carbon additive can comprise, for example, sodiated carbon nanotubes (e.g., carbon nanotubes whose interior pore space comprises sodium incorporated via vapor phase capillary infiltration/nucleation).

### EXAMPLES

To further illustrate the principles of the present disclosure, the following examples are put forth so as to provide those of ordinary skill in the art with a complete disclosure and description of how the compositions, articles, and methods claimed herein are made and evaluated. They are intended to be purely exemplary of the invention and are not intended to limit the scope of what the inventors regard as their disclosure. These examples are not intended to exclude equivalents and variations of the present invention which are apparent to one skilled in the art. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1: Construction of an Anode-Free Sodium Battery Through In-Situ Plating of Sodium Metal

Sodium-ion batteries (SIBs) have been pursued as a more cost-effective and more sustainable alternative to lithium-ion batteries (LIBs), but these advantages come at the expense of energy density. The challenge of energy density for sodium chemistries can be overcome through a herein disclosed “anode-free” architecture using a carbon nucleation layer on a current collector (e.g., an aluminum current collector). Electrochemical studies show that the modified current collectors provide highly stable and efficient plating and stripping of sodium metal over a range of currents (up to 4 mA/cm²) and sodium loadings (up to 12 mAh/cm²) with long-term durability (over 1,000 cycles). A full cell was constructed using a modified current collector and a presodiated pyrite cathode. The full cell achieved energy densities greater than 400 Wh/kg, far surpassing recent reports on SIBs and even the theoretical maximum for LIB technology (387 Wh/kg for LiCoO₂/graphite cells), while still relying on naturally abundant raw materials and cost-effective aqueous processing.

Broader Context

Wind and solar resources, now being deployed in ever increasing amounts, are straining antiquated electricity grids and further jeopardizing reliable delivery of electricity. Both the surpluses and shortages in generation brought on by the variability of these resources are extremely problematic and require energy storage solutions to provide real-time flexibility to the grid. While Lithium-ion batteries offer high energy density, modular functionality, long life spans and maintenance-free operation, their high material costs have effectively excluded them from stationary storage applications. In addition, less costly battery chemistries have failed to provide adequate performance for such applications. As a result, only 1% of global grid-scale energy storage capacity is provided by electrochemical means. However, despite their underutilization, batteries stand out as the best suited energy storage technology to enable the integration of decentralized renewables generation and improve the resiliency of the grid—assuming less costly, high performance batteries can be achieved.

Results and Discussion

To facilitate utilization of the rapidly growing capacity of renewable resources and avoid curtailment of renewable generation without sacrificing grid reliability, batteries are currently needed (and will be increasingly needed) to modernize the electricity grid. SIBs have emerged as the most direct route to developing more cost-effective and more sustainably-produced metal-ion batteries due to their similarity in chemistry to LIBs and the 1000× greater natural abundance of sodium compared to lithium.

The pursuit of a SIB design suitable for commercialization has spurred a recent surge in research activity focused on developing electrodes capable of hosting sodium ions, but the larger ionic radius and less negative standard reduction potential (compared to lithium ions) have limited the energy density of emerging SIB technologies, with recent state-of-the-art full cells demonstrating ˜200 Wh/kg with respect to active mass. On this front, the anode side has proved to be the most challenging, as graphite, the standard LIB anode, cannot intercalate sufficient sodium ions. While alternative anode materials, predominately disordered carbons and alloying metals, such as Sn, Sb or Pb, have been extensively researched with notable progress made, a sodium-ion anode that can deliver high capacity and operate at practical currents without sacrificing cycling performance or coulombic efficiency is yet to be realized.

The continued research effort in this direction begs the question: Is an anode host truly needed? Transitioning to “host-less” sodium metal, in theory, is highly favorable as it offers a capacity of 1166 mAh/g (more than double the charged state of the Sn anode: Na₁₅Sn₄), as well as the lowest achievable redox potential for a sodium anode, which is especially critical in the transition to emerging S and O₂ cathodes. Furthermore, the density of sodium metal also serves to maximize volumetric capacity and achieve high areal loading, making the common tradeoff between gravimetric and volumetric performance obsolete. Finally, since the plating/stripping reactions takes place on the surface, there are no solid-state diffusion limitations, and as a result, extremely high-rate capabilities are possible without relying on high-surface-area electrodes.

Despite these clear advantages of a sodium metal battery, research on sodium metal electrodes is surprisingly sparse. In 2015, it was shown that sodium metal is less stable with carbonate electrolytes than lithium metal, due to the organic solid-electrolyte interface (SEI) formed. More recently, there have been initial reports on controlling this SEI layer, either through the use of alternative electrolytes, notably NaPF₆ in gylme or highly concentrated NaFSI in gylme, to form more stable inorganic SEI layers, or by directly depositing an artificial inorganic SEI layer on sodium metal electrodes. However, there has been no research addressing the accompanying issues associated with the interface between the sodium metal and the current collector, the uneven deposition of sodium, or the large volumetric expansion. Each of these issues have been identified as critical in recent research on current collectors for lithium metal batteries and are important for developing an “anode-free” sodium metal battery.

A new approach is disclosed herein which overcomes both capacity and cycling limitations faced by sodium-ion anodes by abandoning the anode host and instead, plating sodium metal in-situ on an aluminum (Al) current collector equipped with a carbon nucleation layer that functions to both assist the seeding of sodium nucleation and provide structure for sodium plating. The “anode-free” sodium battery provides energy densities surpassing current SIB and LIB chemistries while simultaneously relying on earth-abundant raw materials such as carbon, aluminum and sodium and straight-forward aqueous processing. While the “anode-free” architecture has been inspired by previous efforts to develop lithium batteries using bare Cu current collectors, the herein disclosed unique design was developed by the finding that a high surface area sodiated carbon nucleation layer can be used with Al foil current collectors for highly efficient sodium metal plating/stripping processes. Over a period of 1000 plating-stripping cycles, these current collectors exhibit an average coulombic efficiency of 99.8% and an exceptionally low average hysteresis of 14 mV. High efficiencies and low hystereses are maintained at current densities up to 4 mA/cm² and sodium loadings up to 12 mAh/cm², further showing the versatility of this approach. Images of the sodium plating process reveal hexagonal island growth following initial nucleation, eventually leading to a smooth sodium film formed from coalesced islands. Finally, a full-cell device was assembled using the “anode-free” design with a pre-sodiated pyrite cathode and a carbon-modified Al current collector to realize an energy density greater than 400 Wh/kg with respect to the active materials, proving that this approach has great promise for low-cost, high-performance grid scale application.

Carbon films were assembled on Al foil using conductive carbon black (TIMCAL Super C45) and sodium carboxymethyl cellulose (CMC) with aqueous processing, in line with the recent effort to avoid expensive N-methylpyrrolidone (NMP) processing for battery electrodes. Cathode electrodes were processed in a similar fashion using pyrite (325 mesh), carbon black and CMC on Al foil. An electrolyte of 1M NaPF₆ in diethylene glycol dimethyl ether (diglyme) was used as the electrolyte due to its stability against sodium metal and tendency to form stable SEI layers for sodium-based chemistries. Half-cell testing was performed using flattened sodium metal (˜20 mg) as the counter/reference electrodes with a stripping cutoff potential of 100 mV.

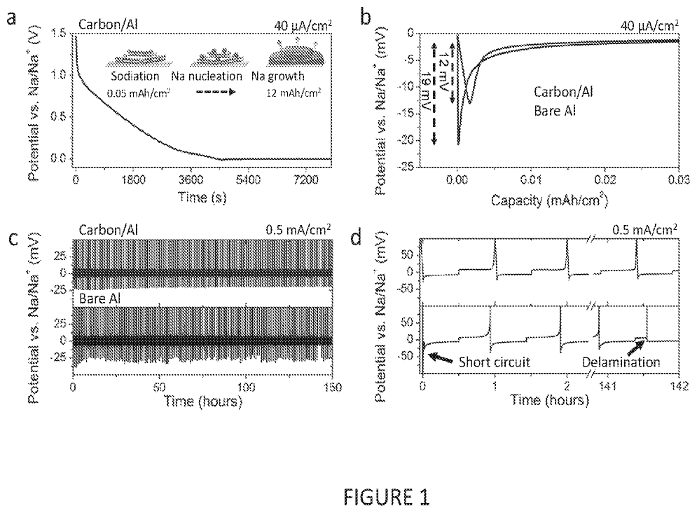

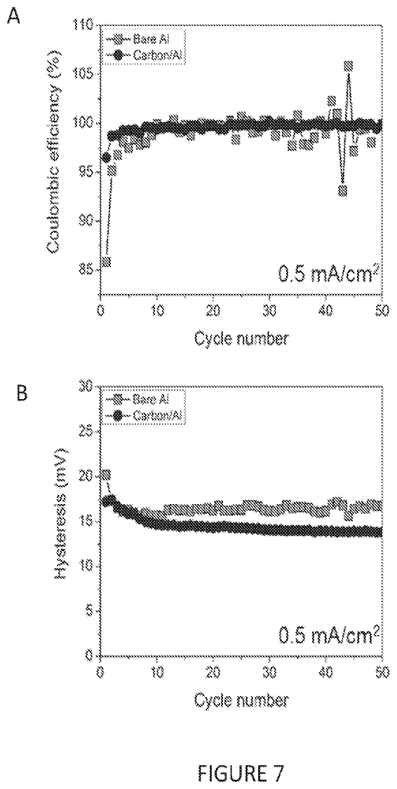

To evaluate the role of the carbon nucleation layer on the sodium plating process, galvanostatic plating at low currents (to minimize diffusion limitations) for both bare Al and carbon/Al substrates was performed. Al was selected instead of Cu because it offers significant cost (˜3× cheaper) and weight (˜3× lighter) benefits—a great advantage made available by transitioning to sodium-based chemistries. FIG. 1A shows the initial sodiation of the carbon/Al current collector, where the sloping potential curve above 0 V vs. Na/Na⁺ corresponds to the storage of sodium ions in disordered carbon and the steady voltage reached below 0V corresponds to the plating of sodium metal. Zooming in on the beginning of the plating process and comparing it to a bare Al current collector (FIG. 1B), it is observed that nucleation overpotential (difference between the bottom of the trough, where nucleation occurs, and the steady-state plating potential) is reduced from 19 mV to 12 mV by the carbon layer. Reducing this nucleation barrier facilitates more uniform plating, minimizing parasitic reactions and allowing for high-rate performance. The improved performance observed can be attributed to the increased surface area provided by the carbon (˜170× increase in surface area for a 400 m/cm² carbon layer), the presence of highly-reactive sp³ carbon sites, and the initial storage of sodium ions in the carbon. On this last point, it is worth noting that it has recently been hypothesized that disordered carbon may facilitate underpotential deposition of sodium metal, which would entail that sodium metal is already present on the carbon prior to the plating process that occurs below 0V vs. Na/Na⁺ Raman spectroscopy was used to further characterize the carbon layer before and after initial sodiation (FIG. 6). These initial findings are the first examination of the importance of substrate on the nucleation of sodium metal and compliment recent work performed by K. Yan et al. on the effect of substrate on the nucleation of lithium plating.

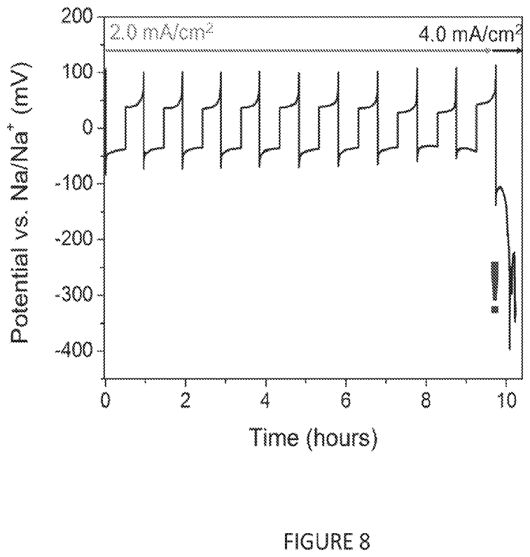

FIG. 1C shows 150 hours of plating/stripping cycles performed at an increased rate of 0.5 mA/cm2. Examining the initial cycles (shown in FIG. 1D), it is observed that during the first plating process, the bare Al electrode exhibits signs of shorting. This is attributed to the uneven plating that occurs due to the higher nucleation overpotential. In contrast, the carbon/Al electrodes demonstrate more stable plating and stripping, improved hysteresis, and higher coulombic efficiency (FIG. 7). Sporadic failure in the Al electrodes at later times was observed, as shown in the 141^{st} cycle where a stripping process is cut short due to delamination of the sodium metal from the current collector. However, such occurrences did not take place in the carbon/Al electrodes, owing to the improved connectivity between the sodium metal and the current collector—a key advantage of this approach.

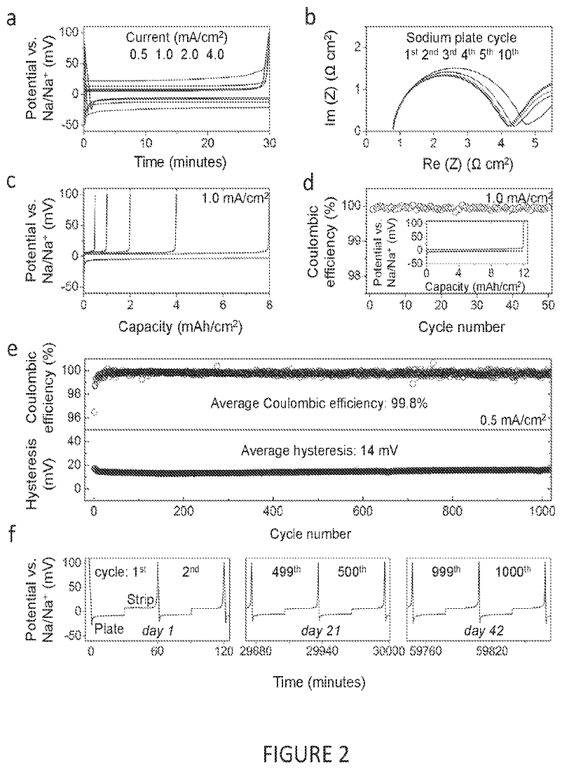

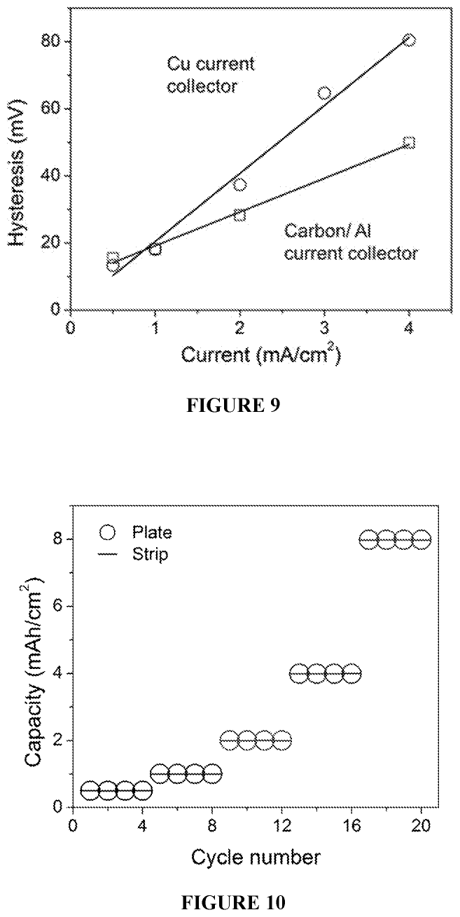

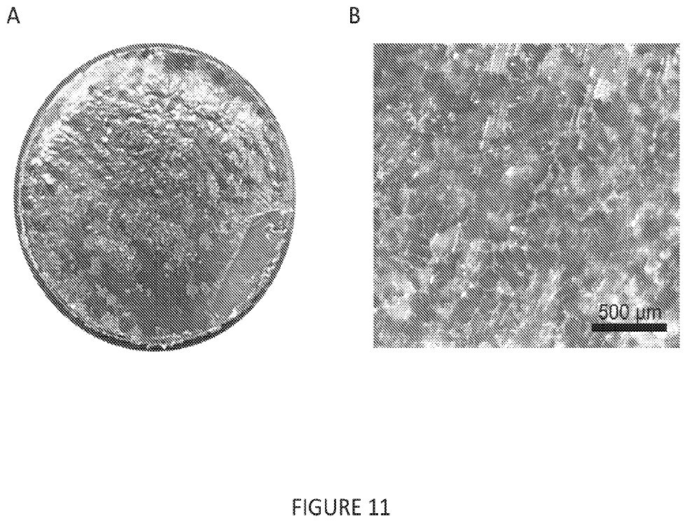

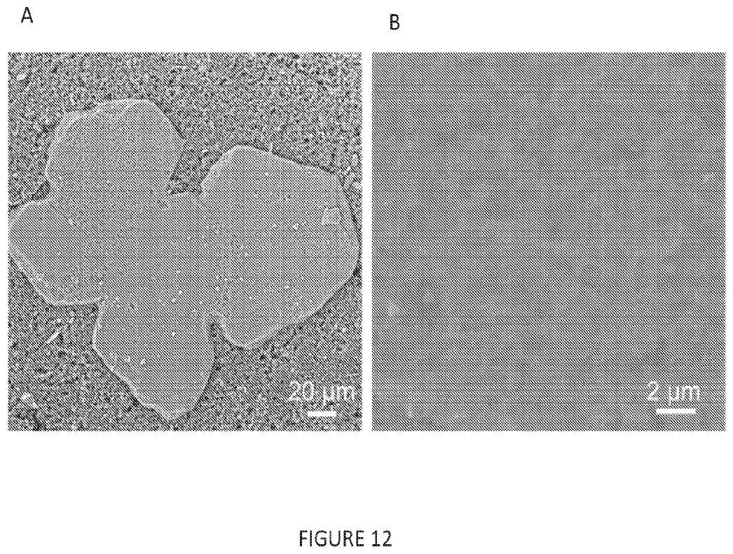

To further assess the carbon/Al electrodes, tests using a range of currents from 0.5 mA/cm² to 4 mA/cm² were conducted. As shown in FIG. 2A, the carbon layer facilitates a low voltage hysteresis even at high currents, with a 45 mV hysteresis at 4 mA/cm². In contrast, bare Al electrodes were prone to failure at these currents (FIG. 8) and even previous work using Cu electrodes reported nearly double the hysteresis at 4 mA/cm² (FIG. 9). This performance was attributed to the improved connectivity between the current collector and the plated sodium. To examine the low hysterysis, electrochemical impedance spectroscopy was performed after initial plating cycles with 0.25 mAh/cm² of fresh sodium (FIG. 2B). These tests showed that charge transfer resistance, corresponding to the diameter of the semicircle in the Nyquist plot, was extremely low and stable with cycling. Next, plating/stripping testing at increased loadings of sodium (FIG. 2C) was performed. It was found that the electrodes exhibited stable performance at 1 mA/cm2 for 30 minutes plating times (0.5 mAh/cm²) up to 8 hour plating times (8 mAh/cm²), with coulombic efficiency slightly increasing with loading (FIG. 10), indicating that the minor losses in the system occur during the initial seeding and/or the final stripping processes. To further demonstrate the versatility of this approach for exceptionally high loadings of sodium, 50 cycles were performed at 12 mAh/cm² with the average coulombic efficiency exceeding 99.9% (FIG. 2D). It is worthwhile to point out here that at 12 mAh/cm² loading, a 400 μg/cm² carbon layer provides a capacity of 30,000 mAh/g if considered an anode host, indicating the mass of the carbon is essentially negligible and the electrode acts more as a current collector than an anode host.

To test long-term durability, over 1000 plating-stripping cycles were run using 30 minute plating times to maximize the initial seeding and final stripping events that appear most problematic (shown in FIG. 2E). Nonetheless, results showed a highly stable hysteresis averaging 14 mV and a highly stable coulombic efficiency averaging 99.8%, with no evidence of short circuiting or delamination. FIG. 2F shows the voltage profiles from the 1^{st}, 2^{nd}, 499^{th}, 500^{th}, 999^{th} and 1000^{th} cycles, which all appear nearly identical, emphasizing the stability maintained during cycling.

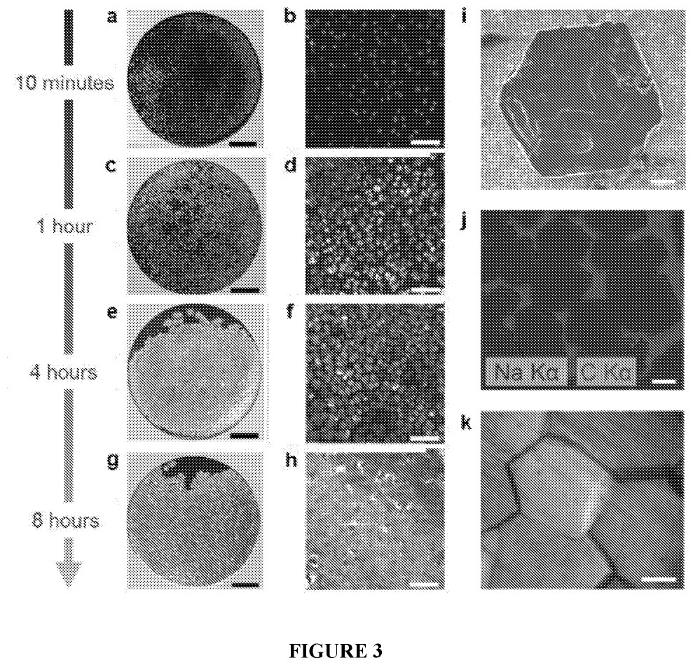

In order to gain insight into the plating process, carbon/Al electrodes were imaged with progressive loading of sodium. FIG. 3 shows electrodes after 10 minutes (A,B), 1 hour (C,D), 4 hours (E,F) and 8 hours (G,H) of plating at 0.5 mA/cm². These images show a progression from the seeding of well-spaced islands of sodium to the growth and coalescence of these islands to form a smooth, shiny film of sodium metal. Interestingly, the islands appear to grow as hexagons, as shown in the scanning electron micrograph (SEM) in FIG. 31, and the hexagonal pattern is maintained as the islands begin to sinter together (shown in the energy dispersive x-ray spectroscopic map in FIG. 3J) and perseveres in the formed film, creating the appearance of polycrystallinity with defined grain boundaries (FIG. 3K). This is the first documentation of such a plating process for alkali metals, which is especially interesting as it underlies extremely efficient and stable electrochemical performance. It is also valuable to point out that no evidence of dendritic growth was observed.

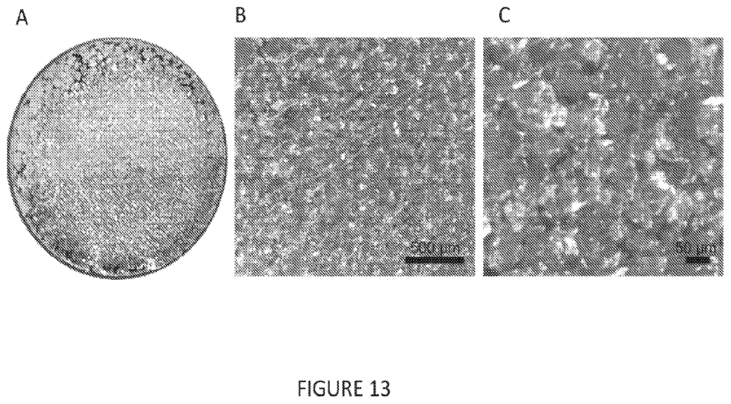

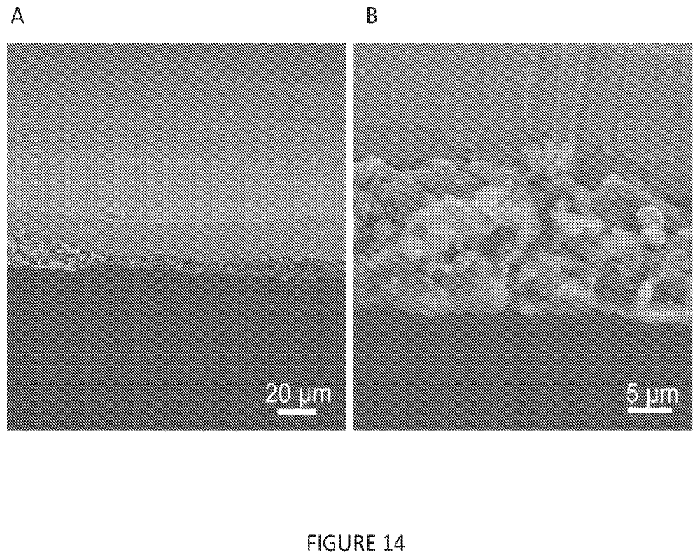

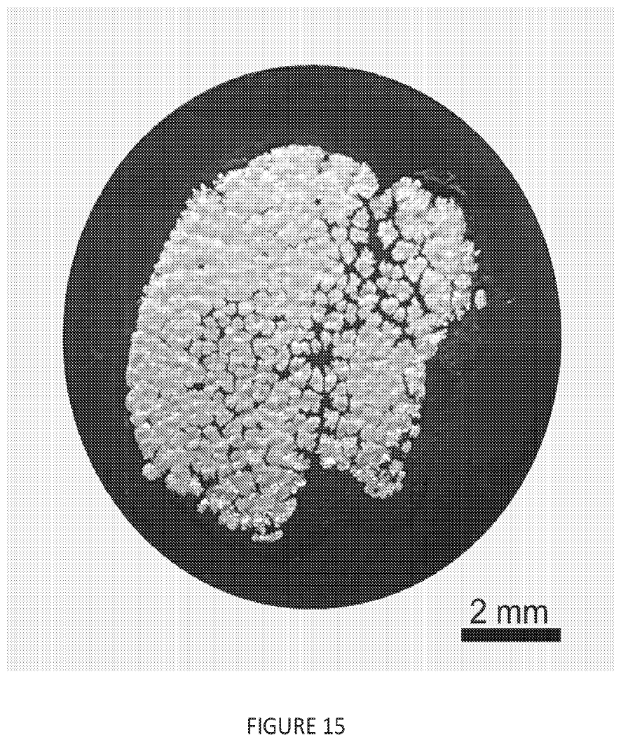

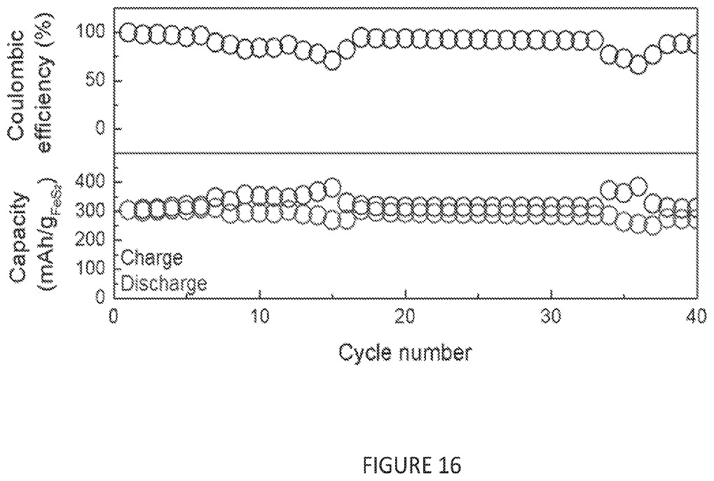

Micrographs of sodium metal plated on a bare Al electrode are shown in FIG. 11. Top-view images of sodium metal plated on a carbon/Al electrode, including close-up views of the surface of the sodium metal, are shown in FIG. 12. Images of sodium metal plated at a higher current on a carbon/Al electrode are shown in FIG. 13. Further, a cross-sectional image of a carbon/Al electrode plated with sodium metal is shown in FIG. 14.

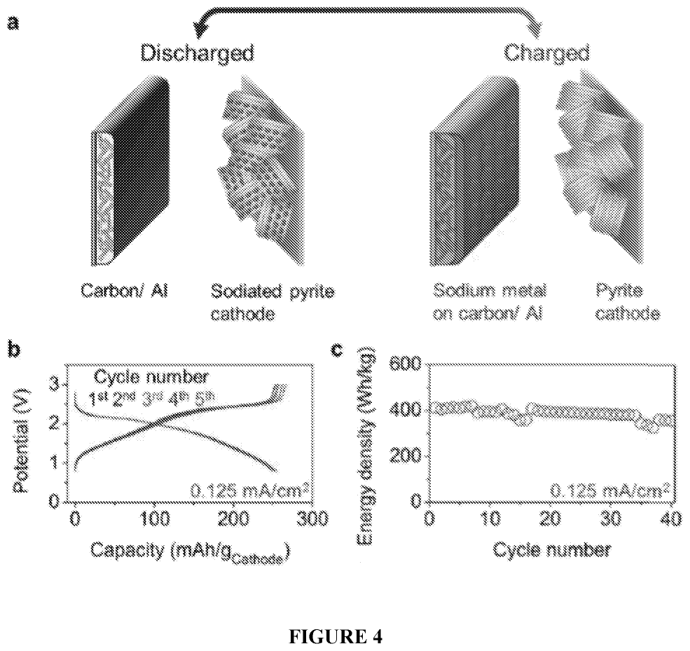

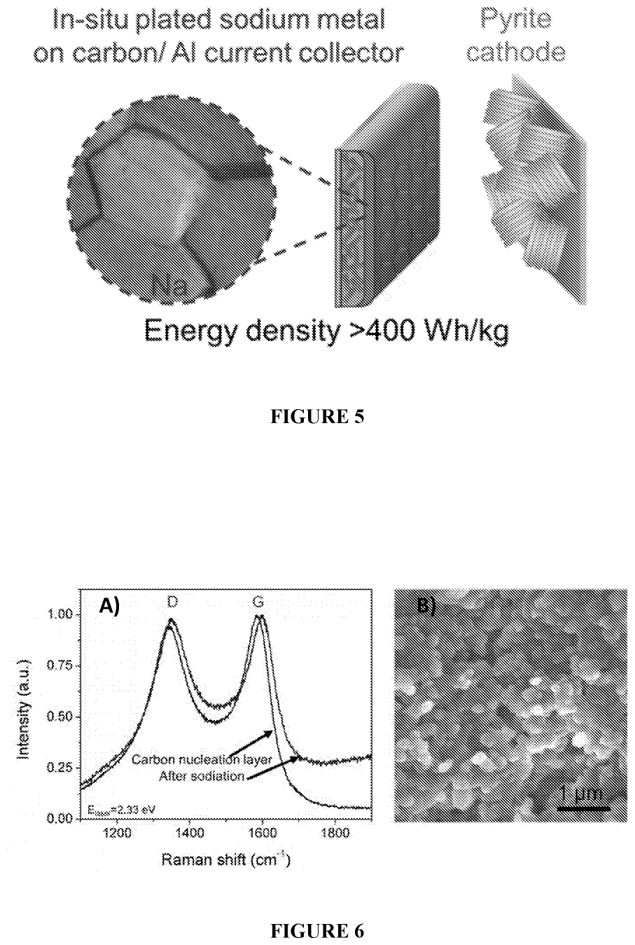

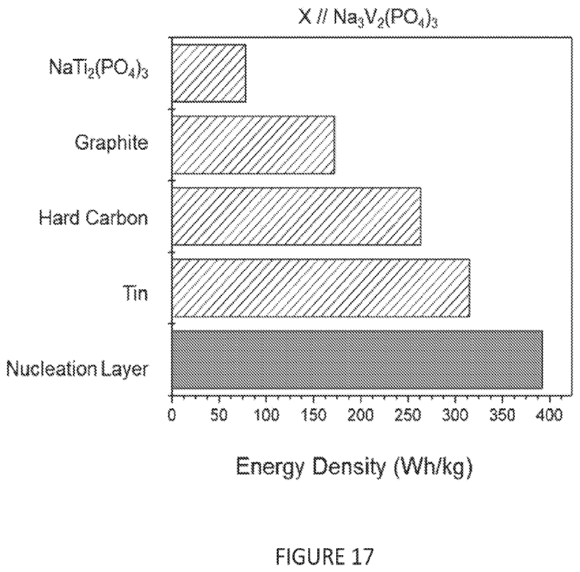

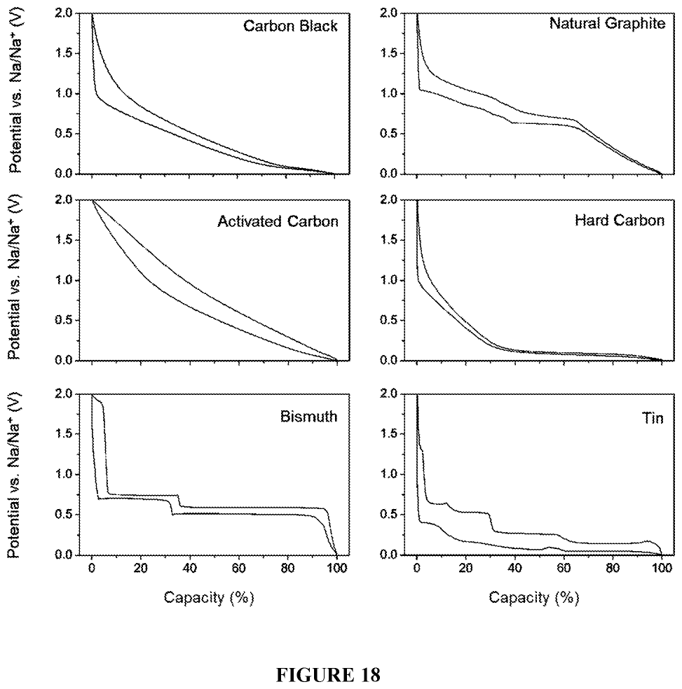

Finally, full cells were assembled and tested to demonstrate the feasibility of the ultimate goal: developing an “anode-free” sodium battery. Pyrite (FeS₂) was used for the cathode because it is a cheap, abundant material that has been shown to be an excellent candidate for SIBs. However, since it does not contain sodium, the pyrite cathode was pre-sodiated prior to cell assembly. Full cells were constructed using pre-sodiated pyrite paired with carbon/Al current collectors, corresponding to a discharged device state, as illustrated in FIG. 4A. During the first charge (voltage profile shown in FIG. 7) sodium ions are removed from pyrite during the oxidation reaction and reduced on the carbon/Al current collector to form sodium metal in situ. In this manner, a sodium metal battery that does not contain sodium metal on assembly was developed. To prove that sodium metal was indeed forming during the charging process, the fully charged full cell was dissembled to show the plated sodium metal on the carbon/Al electrode in FIG. 15. Initial voltage profiles exhibited during galvanostatic testing are shown with respect to the mass of the pre-sodiated pyrite in FIG. 4B for the full cell following the initial charging process. FIG. 16 shows the coulombic efficiency and capacity of the FeS₂ full cell over 40 cycles, while FIG. 4C shows the stability of the delivered energy density over 40 cycles. The 400 Wh/kg energy density, calculated based on the mass of the pre-sodiated pyrite and the carbon layer, exceeds all previous reports for SIBs and, assuming a conservative 50% packaging penalty, exceeds current LIB technology. FIG. 5 describes a pyrite cathode and an in-situ plated sodium metal on a carbon/Al current collector providing 400 Wh/kg energy density. Going forward, cathode alterations can provide increased cycling stability and improved rate capability.

In summary, through the use of a carbon nucleation layer, highly efficient and stable sodium plating and stripping can be achieved to enable a new approach for sodium batteries: the “anode-free” sodium battery. The exceptional energy density and versatility of this approach is the first demonstration that sodium batteries, based on naturally abundant materials and simple aqueous processing, have the promise of outperforming LIB technology and filling the desperately needed demand for a cost-effect, high-performance battery for grid-scale storage.

Methods

Electrochemical Measurements.

Carbon films were assembled on Al foil using a mixture of conductive carbon black (TIMCAL Super C45) and sodium carboxymethyl cellulose (CMC) with a ratio of 8:2, respectively. Triton X-100 0.35 weight percent (wt %) in deionized water was used at the solvent. Slurries were then doctor bladed onto Al foil to obtain carbon films with ˜400 μg/cm². FeS₂ electrodes were processed similarly using a ratio of 8:1:1 for FeS₂ (325 mesh): carbon black:CMC. FeS₂ electrodes were tested with active mass loading of ˜5 mg/cm².

Electrochemical testing was performed at room temperature in CR2032 coin cells using Celgard 2325 separators. Half-cell testing was performed using ˜20 mg of flattened sodium metal (Strem Chemicals, 99.95%) as the reference and counter electrode. The 1M NaPF₆ in diethylene glycol dimethyl ether (99.5%, Sigma-Aldrich) electrolyte was prepared after NaPF₆ salt, acquired from Strem Chemicals with a purity of 99%, was dried at 100 C for 24 hours in Ar.

Prior to plating/stripping testing, all devices were initially galvanostatically cycled 10 times at 0.4 mA/cm² from 0.01 to 1.0 V vs. Na/Na⁺ to remove any surface contamination. Plating/stripping testing was performed using a stripping cutoff voltage of 100 mV vs. Na/Na⁺ Coulombic efficiencies were calculated as the capacity ratio of the Na removed/Na deposited. The voltage hysteresis for each cycle was calculated as the difference between the average voltage measured for corresponding plating and stripping steps. Coulombic efficiency values exceeding 100% for individual cycles may be attributed to the stripping of sodium metal that was left behind after previous cycles.

Electrochemical impedance spectroscopy (EIS) was performed on 0.25 mAh/cm² of plated sodium (0.5 mA/cm² for 30 minutes) after the 1^{st}, 2^{nd}, 3^{nd}, 4^{th}, 5^{th} and 10^{th} cycles in half cell configurations with a Na metal reference/counter electrode. EIS was performed using a Metrohm Autolab multichannel electrochemical workstation.

Sodium Imaging.

In order to image the plated Na metal, plating was performed in a split-flat cell in an Ar glovebox connected to a single-channel Metrohm Autolab. After plating, electrodes were removed from the glovebox, sealed between two glass slides using a greased O-ring secured with binder clips. To perform the SEM imaging, a “pop-top” transfer cell was made utilizing a taught rubber membrane positioned underneath a needle, so that the membrane bursts when placed under vacuum in the SEM loading chamber to expose the sample to the electron beam in a similar fashion to the cell reported in Ref. 1. A Zeiss MERLIN with GEMINI II SEM.

Anode Free Full Cells.

Prior to assembling full cells, FeS₂ electrodes were pre-sodiated in shorted cells with Na metal, a Celgard 2325 separator, and 1M NaPF₆ diglyme electrolyte for 24 h. The pre-sodiated FeS₂ electrodes were then dried and paired with a carbon/Al negative electrode using a Celgard 2325 separator and 1M NaPF₆ diglyme electrolyte and assembled into CR2032 coin cells. After cell assembly, full cells were galvanostatically charged to 3.0 V prior to cycling.

Energy density calculations were based on the weight of the carbon black on the negative side and the pre-sodiated FeS₂ on the positive side, assuming a stoichiometry of Na_{1.5}FeS₂, which would correspond to a FeS₂ specific capacity of ˜335 mAh/g. In comparison, if the mass of the active Na is not accounted for, the energy density would be calculated to be ˜500 Wh/kg.

### Example 2: Alternative Nucleation Layers

In a second example, current collectors were prepared using methods similar to those described in Example 1, except that the composition of the nucleation layer was altered.

Nucleation layer coatings formed from either tin, carbon black, hard carbon, graphite, or supercap carbon were deposited on aluminum current collectors.

The nucleation layers were prepared by mixing 70% (by weight) active material (tin, hard carbon, etc.) with 10% carbon black (TIMICAL SUPER C45 Conductive Carbon Black) and 20% carboxymethyl cellulose binder. A slurry was then obtained by adding water and mixing. The slurry was subsequently doctor-bladed onto aluminum foil. After drying, 1 cm diameter disks were punched out of the coated foil and used as the positive electrodes in half cell testing. Half cells were assembled in an argon glove box (<1 ppm 02) using CR2032 coin cell cases. Sodium metal was pressed flat onto a stainless steel disk (1.55 cm diameter) to serve as the negative electrode. Celgard 2325 separator (cut to 1.7 cm diameter circle) was used to electrically separate the positive and negative electrodes. An electrolyte of 1M NaPF₆ in diglyme was freshly prepared in the glovebox and used to ionically connect the positive and negative electrodes. Coin cells were crimped prior to removal from the glovebox and electrochemical testing.

Materials tested as nucleation layers included: tin (325 mesh), bismuth (325 mesh), activated carbon (surface area: 2,000 m2/g), natural graphite flakes, hard carbon (synthesized by dewatering a sugar solution in an autoclave and then pyrolyzing at 1000° C. in under an argon flow), and carbon black (TIMICAL SUPER C45 Conductive Carbon Black).

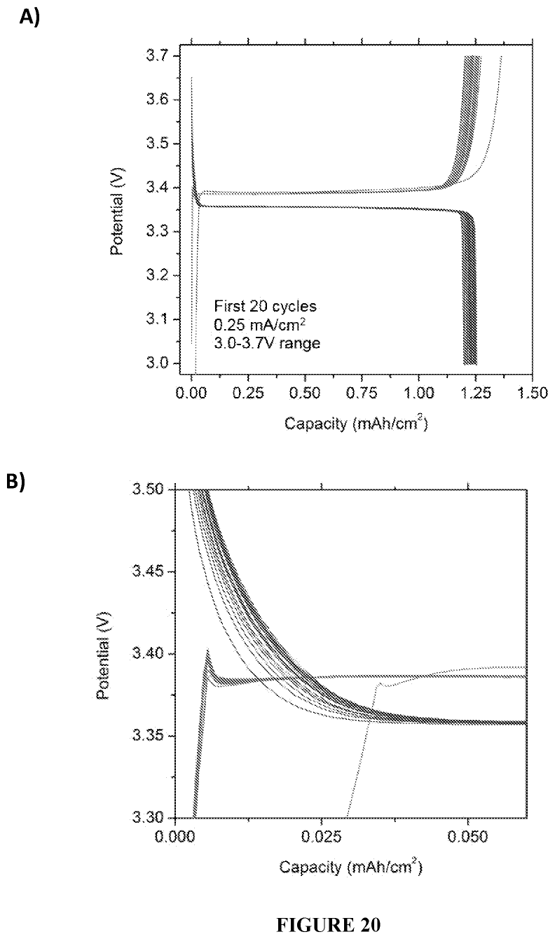

FIG. 18 shows the galanostatic sodiation/desodiation potential profiles of the different nucleation layers as tested in half cells at 0.1 A/g with respect to the active material in the voltage range of 0 to 2V vs. Na/Na⁺. The lower cutoff at 0 V vs. Na/Na⁺ prevents plating from occurring. As shown in FIG. 18, certain nucleation layers provide at least 99.9% coulombic efficiency, making them particularly promising candidates for incorporation into batteries.

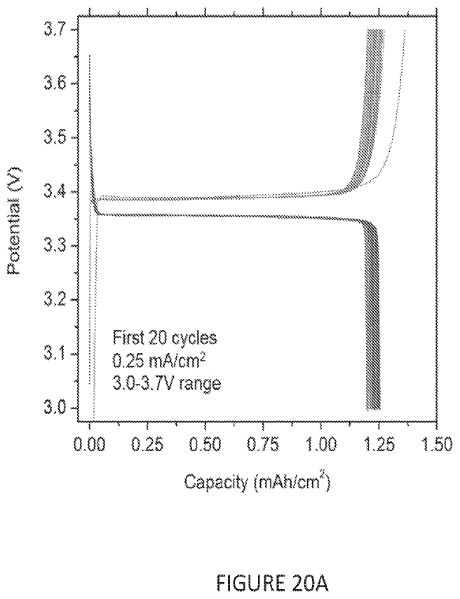

FIG. 19 shows the first 50 cycles of the galvanostatic plating and stripping of 0.5 mAh/cm² of sodium metal at a current density of 0.5 mA/cm² with a 50 mV voltage cutoff (following an initial sodiation of these nucleation layers). Each cycle is plotted from the end point of the prior cycle, so the shift to the right of the plot with cycling corresponds to the loss of charge in the system. The initial downward spike in the voltage corresponds to the nucleation overpotential and the subsequent long plateau that occurs at a negative voltage corresponds to the plating of sodium. As each loop reverses, the long plateau that occurs at a positive voltage corresponds to the stripping of sodium metal, and then the final increase in voltage corresponds to the exhaustion of the sodium metal.

Bismuth and tin are both known to alloy with sodium, and show a reduced nucleation overpotential spike. In these experiments, the activated carbon and the tin exhibited the lowest coulombic efficiency (as seen with the rightward shift). The carbon black exhibited the highest coulombic efficiency, ca. 99.9%.

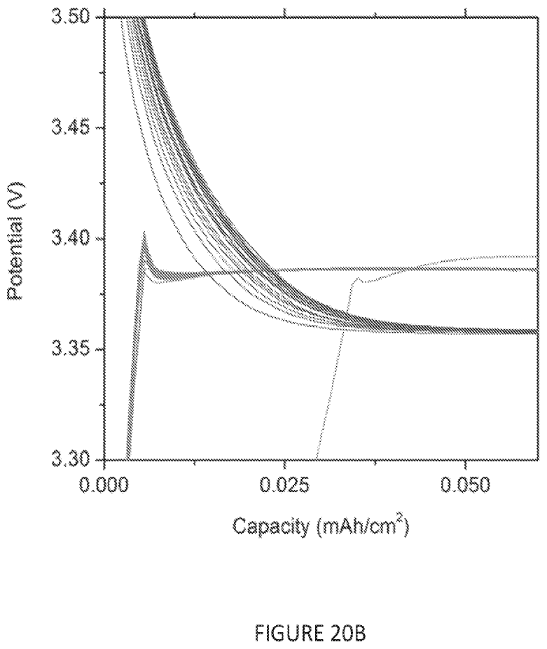

FIG. 20A shows the first 20 galvanostatic charge discharge profiles for an anode-free cell using a Na₃V₂(PO₄)₃ cathode, performed at 0.25 mA/cm² (˜C/6). During each discharge to 3.0 V, all of the sodium is stripped from the nucleation layer and inserted into the cathode. Charging to 3.7 V reverses this process, plating sodium back on the nucleation layer. FIG. 20B shows a zoomed in plot of the start of the charging process. The upward spike corresponds to the nucleation overpotential, indicating that sodium is fully removed each cycle.

### Example 3: Anode-Free Cells Using Alternative Cathode Materials

In a third example, electrochemical cell was prepared using varying cathode materials. In one example, Na₃V₂(PO₄)₃ was used as a cathode material. Briefly, V₂O₅, NaH₂PO₄.H₂O, and citric acid were combined in a molar ratio of 1:3:3 and then ball milled in ethanol in a planetary ball at 300 RPMs for 24 hours. The resulting green slurry was then dried, hand ground using a mortar and pestle, and sintered at 350° C. under an Argon flow for 4 hours. The sintered material was then hand ground using a mortar and pestle, pressed into 1 cm diameter disks, sintered at 800° C. under an Argon flow for 8 hours. These sintered disks were then hand ground using a mortar and pestle, and carbonized under a flow of Argon and C₂H₂ (90:10 volumetric flow rate ratio) starting a 600° C. and ramping to 690° C. over 30 minutes.

Electrodes were prepared by mixing Na₃V₂(PO₄)₃ with carbon black (conductive additive) and carboxymethyl cellulose (binder) using water as the solvent and spread onto aluminum foil. After drying electrodes contained around 13 mg/cm² of Na₃V₂(PO₄)₃. Coin cells were assembled using these Na₃V₂(PO₄)₃ containing electrodes as the positive electrode and carbon black on Al foil (0.2 mg/cm²) as the negative electrode, 2 separators, and 1M NaPF₆ in diglyme as the electrolyte.

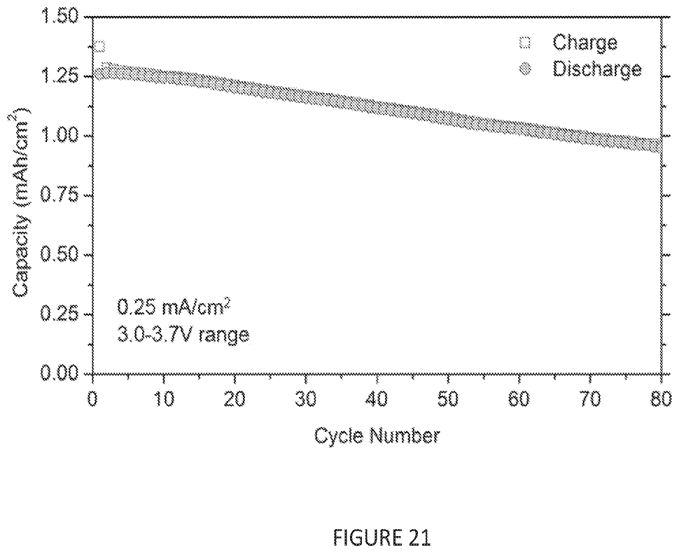

Performance of a full cell comprising a Na₃V₂(PO₄)₃ cathode, carbon black nucleation layer, glyme electrolyte, and polymer or glass fiber separator is shown in FIG. 21. FIG. 21 shows the first 80 galvanostatic charge discharge cycles for an anode-free cell using a Na₃V₂(PO₄)₃ cathode, performed at 0.25 mA/cm² (˜C/6). The decrease in capacity with cycling is due to the slow loss of sodium to parasitic reactions. Greater than 97% energy efficiency was achieved in this cell configuration.

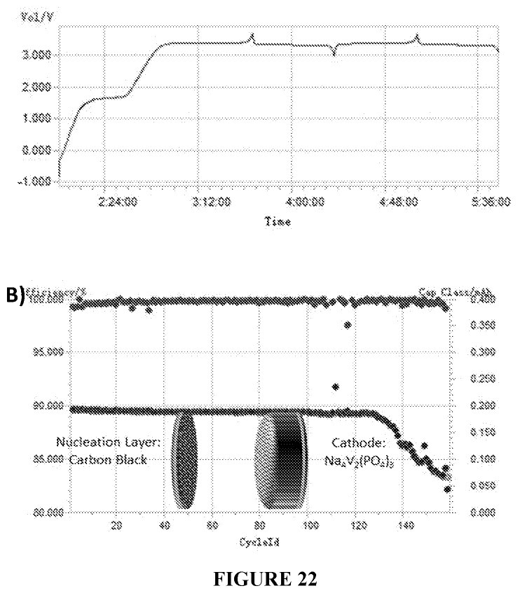

In another example, a second sodium-vanadium phosphate cathode was formed using Na₄V₂(PO₄)₃ as the cathode material. In this way, the resulting electrochemical cell was loaded with additional sodium to be plated on the nucleation layer. In order to demonstrate this concept, an Na₃V₂(PO₄)₃ electrode was first assembled in a half cell configuration, with a sodium metal counter electrode, an 2325 separator, and 1M NaPF₆ diglyme, and then galvanostatically discharged to 1V vs. Na/Na⁺. This process serves to electrochemically sodiate the Na₃V₂(PO₄)₃ electrode, to form Na₄V₂(PO₄)₃. The half cell was then disassembled in the glovebox and the electrode was removed and used for an anode-free cell, where the counter electrode was a carbon black nucleation layer. During the first charge, the additional sodium added to the NVP electrode is removed from the cathode, first sodiating the nucleation layer and then facilitate the plating (ca. 1.6 V), all prior to the standard ca. 3.4V charging. After this first charge, this surplus sodium is left on the negative electrode and is not reinserted into the cathode (shown in FIG. 22A). However, it could be advantageous to reinsert it for cell storage or transportation. This method extends the cycle life by introducing additional sodium into the cell (FIG. 22 B)

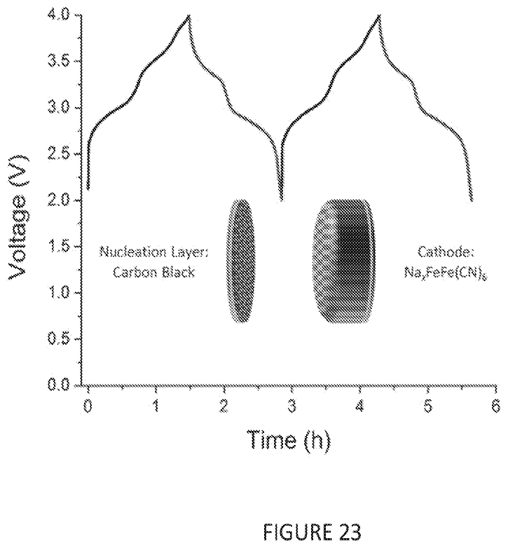

In another example, an electrochemical cell was prepared using Prussian Blue (NaₓFeFe(CN)₆) as the cathode material. Care was taken to minimize oxygen exposure during the synthesis to maximize the initial sodium content, with the final stoichiometry of approximately Na_{1.3}FeFe(CN)₆. The Prussian blue was synthesized as follows. Briefly, 595 mg of FeCl₂.4H₂O and 2000 mg of sodium citrate were added to 100 ml of deionized water and bubbled with nitrogen. 970 mg of Na₄Fe(CN)₆.10H₂O and 2920 mg of NaCl were added to a second flask with 100 ml of deionized water and bubbled with nitrogen. After 30 minutes, the first solution was added into the second, and the mixture was stirred for 4 hours at room temperature under nitrogen. Repeated washing with IPA and water and centrifugation were then performed prior to drying and electrode assembly. Electrodes were formed using carbon black and CMC as previously described. Prior to anode-free cell assembly, Prussian Blue electrodes were initially cycled in a half cell configuration with a sodium metal counter electrode. FIG. 23 shows galvanostatic cycling of an anode-free cell using a Prussian blue cathode at a rate of ca. 0.1 A/g with respect to the mass of the Prussian Blue between 2.0 and 4.0 V.

Publications cited herein are hereby specifically incorporated by reference in their entireties and at least for the material for which they are cited.

Lastly, it should be understood that while the present disclosure has been provided in detail with respect to certain illustrative and specific aspects thereof, it should not be considered limited to such, as numerous modifications are possible without departing from the broad spirit and scope of the present disclosure as defined in the appended claims. It is, therefore, intended that the appended claims cover all such equivalent variations as fall within the true spirit and scope of the invention.

We claim:

1. An electrochemical cell comprising:
a first metal current collector having a nucleation layer disposed on a surface of the first metal current collector;
a second metal current collector having a cathode material disposed on a surface of the second metal current collector; and
a sodium electrolyte.

2. The cell of claim 1, wherein the first metal current collector comprises an aluminum current collector.

3. The cell of any of claims 1-2, wherein the second metal current collector comprises an aluminum current collector.

4. The cell of any of claims 1-3, wherein the cathode material comprises sodium.

5. The cell of any of claims 1-4, wherein the cathode material comprises sodiated pyrite.

6. The cell of any of claims 1-5, wherein the sodium electrolyte comprises NaPF₆, NaFSI, or a combination thereof.

7. The cell of any of claims 1-6, wherein the sodium electrolyte comprises diglyme.

8. The cell of any of claims 1-7, wherein the nucleation layer comprises a carbon nucleation layer.

9. The cell of any of claims 1-8, wherein the nucleation layer comprises disordered carbon.

10. The cell of any of claims 1-9, wherein the nucleation layer comprises carbon black.

11. The cell of any of claims 8-10, wherein the nucleation layer is present at an areal loading of 400 μg/cm² or less on the surface of the first metal current collector.

12. The cell of any of claims 1-11, wherein the electrochemical cell exhibits an energy density of greater than 400 Wh/kg with respect to active mass.

13. The cell of any of claims 1-12, further comprising a layer of sodium metal plated on the nucleation layer.

14. A process for preparing an electrochemical cell, the process comprising:
(a) providing a first metal current collector having a nucleation layer disposed on a surface of the first metal current collector; a second metal current collector having a cathode material disposed on a surface of the second metal current collector; and a sodium electrolyte; and
(b) plating sodium onto the nucleation layer.

15. The process of claim 14, wherein the nucleation overpotential observed during plating is less than 19 mV, measured at room temperature using a current of 0.5 mA/cm² in a half cell using a coin cell configuration in 1M NaPF₆ diglyme electrolyte with a 25 micron porous separator.

16. The process of any of claims 14-15, wherein the first metal current collector comprises an aluminum current collector.

17. The process of any of claims 14-16, wherein the second metal current collector comprises an aluminum current collector.

18. The process of any of claims 14-17, wherein the cathode material comprises sodium.

19. The process of any of claims 14-18, wherein the cathode material comprises sodiated pyrite.

20. The process of any of claims 14-19, wherein the sodium electrolyte comprises NaPF₆, NaFSI, or a combination thereof.

21. The process of any of claims 14-20, wherein the sodium electrolyte comprises diglyme.

22. The process of any of claims 14-21, wherein the nucleation layer comprises a carbon nucleation layer.

23. The process of any of claims 14-22, wherein the nucleation layer comprises disordered carbon.

24. The process of any of claims 14-23, wherein the nucleation layer comprises carbon black.

25. The process of any of claims 22-24, wherein the nucleation layer is present at an areal loading of 400 μg/cm² or less on the surface of the first metal current collector.

26. The process of any of claims 14-25, wherein the electrochemical cell exhibits an energy density of greater than 400 Wh/kg with respect to active mass.

27. An electrochemical cell comprising:
a first metal current collector having a nucleation layer disposed on a surface of the first metal current collector;
a second metal current collector having a cathode material disposed on a surface of the second metal current collector; and
a sodium electrolyte disposed between the first metal current collector and the second metal current collector.

28. The cell of claim 27, wherein the first metal current collector comprises an aluminum current collector.

29. The cell of any of claims 27-28, wherein the second metal current collector comprises an aluminum current collector.

30. The cell of any of claims 27-29, wherein the cathode material comprises sodium.

31. The cell of any of claims 27-30, wherein the cathode material comprises a sodium transition metal oxide, a sodium transition metal phosphate, a sodium transition metal fluorophosphate, a sodium transition metal pyrophosphate, a sodium transition metal sulfate, a metal sulfide, a Prussian Blue, or a combination thereof.

32. The cell of any of claims 27-31, wherein the cathode material is prepared by a process that comprises mixing or milling the cathode material with sodium metal to incorporate sodium into the cathode material.

33. The cell of any of claims 27-32, wherein the cathode material comprises sodium vanadium phosphate.

34. The cell of any of claims 27-32, wherein the cathode material comprises sodiated pyrite.

35. The cell of any of claims 27-32, wherein the cathode material further comprises a conductive carbon material such as carbon black, a binder, or a combination thereof.

36. The cell of claim 35, wherein the binder is chosen from PVDF, PEO, PTFE, SBR (Styrene Butadiene Rubber), acrylic emulsion polymers, a cellulosic polymer, and combinations thereof.

37. The cell of any of claims 27-36, wherein the cathode material is present at an areal loading of from 0.1 to 100 mg/cm² on the surface of the second metal current collector.

38. The cell of any of claims 27-37, wherein the sodium electrolyte comprises a sodium salt dissolved in a non-aqueous solvent.

39. The cell of claim 38, wherein the sodium salt comprises NaPF₆, NaFSI, or a combination thereof.

40. The cell of any of claims 38-39, wherein the non-aqueous solvent comprises an ether.

41. The cell of any of claims 38-40, wherein the non-aqueous solvent comprises diglyme.

42. The cell of any of claims 27-41, wherein the nucleation layer comprises a carbon nucleation layer.

43. The cell of any of claims 27-42, wherein the nucleation layer comprises amorphous carbon.

44. The cell of any of claims 27-43, wherein the nucleation layer comprises carbon black, carbon nanotubes, graphene, hard carbon, activated carbon, or a combination thereof.

45. The cell of any of claims 27-41, wherein the nucleation layer comprises a bismuth nucleation layer, a tin nucleation layer, a metal sulfide nucleation layer, a metal oxide nucleation layer, an antimony nucleation layer, or a phosphorous nucleation layer.

46. The cell of any of claims 27-45, wherein the nucleation layer is present at an areal loading of less than 2 mg/cm² on the surface of the first metal current collector, such as from 20 μg/cm² to 2 mg/cm², from 50 μg/cm² to 2 mg/cm², from 100 μg/cm² to 2 mg/cm², from 200 μg/cm² to 2 mg/cm², from 400 μg/cm² to 2 mg/cm², from 20 μg/cm² to 1 mg/cm², from 50 μg/cm² to 1 mg/cm², from 100 μg/cm² to 1 mg/cm², from 200 μg/cm² to 1 mg/cm², or from 400 μg/cm² to 1 mg/cm².

47. The cell of any of claims 27-46, wherein the device exhibits an energy density of greater than 300 Wh/kg with respect to active mass, such as greater than 400 Wh/kg, from 300 Wh/kg to 1000 Wh/kg, or from 400 Wh/kg to 1000 Wh/kg, with respect to active mass.

48. The cell of any of claims 27-47, further comprising a separator disposed between the first metal current collector and the second metal current collector.

49. The cell of claim 48, wherein the separator comprises a porous polymer membrane.

50. The cell of claim 48, wherein the separator comprises a glass fiber mat.

51. The cell of any of claims 27-50, wherein the device exhibits a ratio of energy discharged to energy stored of at least 97%.

52. The cell of any of claims 27-51, further comprising a layer of sodium metal plated on the nucleation layer.

53. A process for preparing an electrochemical cell, the process comprising:
(a) providing a first metal current collector having a nucleation layer disposed on a surface of the first metal current collector; a second metal current collector having a cathode material disposed on a surface of the second metal current collector; and a sodium electrolyte in contact with the nucleation layer and the cathode material; and
(b) plating sodium onto the nucleation layer.

54. The process of claim 53, wherein the nucleation overpotential observed during plating is less than 19 mV, measured at room temperature using a current of 0.5 mA/cm² in a half cell using a coin cell configuration in 1M NaPF₆ diglyme electrolyte with a 25 micron porous separator.

55. The process of any of claims 53-54, wherein the nucleation overpotential observed during plating is from 10 mV to 19 mV, measured at room temperature using a current of 0.5 mA/cm² in a half cell using a coin cell configuration in 1M NaPF₆ diglyme electrolyte with a 25 micron porous separator.

56. The process of any of claims 53-55, wherein the cathode material comprises a sodiated sodium transition metal phosphate, such as Na₃₊ₓV₂(PO₄)₃ where 0<x≤2, prior to plating, and wherein the cathode material comprises a sodium transition metal phosphate, such as NaV₂(PO₄)₃, following plating.

57. The process of any of claims 53-56, further comprising depositing the cathode material on the surface of the second metal current collector.

58. The process of claim 57, wherein depositing the cathode material comprises combining the cathode material with a binder to form a mixture, and casting the mixture onto the surface of the second metal current collector.

59. The cell of any of claim 1-13 or 27-52 or the process of any of claim 14-26 or 53-58, wherein the nucleation layer reduces the nucleation overpotential of sodium metal deposition by at least 20% relative to bare aluminum foil, measured at room temperature using a current of 0.5 mA/cm² in a half cell using a coin cell configuration in 1M NaPF₆ diglyme electrolyte with a 25 micron porous separator.

60. The cell of any of claim 1-13, 27-52, or 59, or the process of any of claim 14-26 or 53-59, wherein the electrochemical cell exhibits a cathode capacity per cm² that is at least 70% greater than the sodium ion storage capacity of the nucleation layer per cm².

61. A method for increasing the cycle life of an electrochemical cell, the method comprising:
(a) providing a electrochemical cell comprising a first metal current collector; a second metal current collector having a cathode material disposed on a surface of the second metal current collector; and a sodium electrolyte disposed between the first metal current collector and the second metal current collector; and
(b) incorporating a sacrificial sodium source in the electrochemical cell prior to assembly.

62. The method of claim 61, wherein step (b) comprises combining the cathode material with a sacrificial sodium additive.

63. The method of claim 62, wherein the additive is chosen from sodium metal, Na₂CO₃, Na₃N, Na₃P, and combinations thereof.

64. The method of claim 61, wherein step (b) comprises electrochemical sodiation of the cathode material.

65. The method of claim 64, wherein the cathode material comprises Na₃V₂(PO₄)₃, and electrochemical sodiation of the cathode material produces Na₄V₂(PO₄)₃.

66. The method of claim 61, wherein step (b) comprises combining the cathode material with a sodium sink, and sodiating the sodium sink.

67. The method of claim 66, wherein the sodium sink comprises a material that has a greater sodium capacity than the second metal current collector, the cathode material, or a combination thereof.

68. The method of any of claims 66-67, wherein the sodium sink comprises tin.

69. The method of any of claims 66-68, wherein sodiating the sodium sink comprises electrochemically sodiating the sodium sink.

70. The method of claim 61, wherein step (b) comprises combining the cathode material with a sodiated conductive additive.

71. The method of claim 70, wherein the sodiated conductive additive comprises a sodiated carbon additive.

72. The method of any of claims 70-71, wherein the sodiated conductive additive comprises sodiated carbon nanotubes.

73. The method of claim 72, wherein the sodiated carbon nanotubes comprise carbon nanotubes whose interior pore space comprises sodium incorporated via vapor phase capillary infiltration/nucleation.

74. A sodium battery, wherein the sodium battery exhibits a ratio of energy discharged to energy stored of at least 97%.

75. A sodium battery comprising:
a first metal current collector having a nucleation layer disposed on a surface of the first metal current collector;
a second metal current collector having a cathode material disposed on a surface of the second metal current collector; and
a sodium electrolyte disposed between the first metal current collector and the second metal current collector,
wherein the mass-specific energy density of the sodium battery, measured with respect to the mass of active cathode material and the mass of the nucleation layer, is at least 80% of the energy density of the second metal current collector and the cathode material tested in a half cell configuration with a sodium metal counter electrode, measured only with respect to the mass of active cathode material.

76. A sodium battery comprising:
a first metal current collector having a nucleation layer disposed on a surface of the first metal current collector;
a second metal current collector having a cathode material disposed on a surface of the second metal current collector; and
a sodium electrolyte disposed between the first metal current collector and the second metal current collector,
wherein the mass-specific energy density of the sodium battery, measured with respect to the mass of active cathode material and the mass of the nucleation layer, is at least 40% greater than mass-specific energy density of a sodium-ion battery containing a hard carbon anode, measured with respect to the mass of active cathode material and active anode material.
